(19) United States
(12) Patent Application Publication
(10) Pub. No.: US 2005/0049917 A1
(43) Pub. Date: Mar. 3, 2005

(54) Reciprocal tangible-promotional-materials presentations enabling systems and methods

(76) Inventor: Thomas Andrew Fink, Kettering, OH (US)

Correspondence Address: Thomas Andrew Fink, Apartment 3, 1050 West Dorothy Lane, Kettering, OH, 45409, US

(21) Appl. No.: 10/857,485

(22) Filed: May 29, 2004

Related U.S. Application Data
(60) Provisional application No. 60/498,630, filed on Aug. 28, 2003.

(51) Int. Cl. G06F 17/60

(52) U.S. Cl. 705/14

(57) ABSTRACT

Systems and methods consistent with the present invention enable reciprocal tangible-promotional-materials presentations (RTPMP). An electronic RTPMP enabler services a group of entities with associated individuals. Electronic enabling services include RTPMP data gathering, storage, processing, and communication. The preferred embodiment is a website implemented on the worldwide Internet. The website provides RTPMP enabling services and RTPMP management services. The website generally operates in stages including a data gathering stage, a reciprocator choice stage, a proposal stage, a performance stage, a feedback stage, and a management stage. The management stage allows users to gain knowledge from data from completed RTPMP.

### CROSS-REFERENCE TO RELATED APPLICATIONS

This application is entitled to the benefit of Provisional Patent Application Ser. No. 60/498,630 filed Aug. 28, 2003.

### BACKGROUND

In the competitive environment of a free-market economy, small businesses face significant challenges. The short life span of many small businesses is testimony to these challenges. Among the greatest of these challenges for small businesses is the challenge of attracting customers.

With the benefits of information-technology developments such as search engines and banner exchanges, the online operating environment has improved enough to allow certain types of small businesses to attract customers online. Several inventors have attempted to further improve the online operating environment with additional information-technology developments. These developments include the following. U.S. patent application Ser. No. 10/396,695 by Vulkan discloses an electronic communication method that offers shoppers virtual package deals. U.S. patent application Ser. No. 09/166,405 by Walker, et al discloses a method wherein a bonus is provided to the customer in exchange for consummating a transaction with the soliciting merchant to define routing of customers between merchants. U.S. patent application Ser. No. 09/771,491 by Joao discloses a method wherein the processor calculates at least one of a commission and a referral fee to effectuate an affiliated marketing relationship. U.S. patent application Ser. No. 09/978,589 by Perkes, et al discloses a business method that allows advertisers to promote products and services to targeted customers and to provide credits and coupons to customers as an inducement to viewing or sampling advertising content. U.S. patent application Ser. No. 09/862,356 by Tendon, et al discloses a method wherein consumers are allowed to earn, spend and trade M-points for the establishment of a virtual marketplace of promotional values for the consumers. U.S. Pat. No. 6,285,986 by Andrews discloses a method for combining products or services from one or more vendors together to be sold as a unit. International patent application, published under the patent cooperation treaty, application number PCT/US/00/26803 by Christensen, et al discloses a method to improve the buying, selling and bartering of non-unique items and determine the fair market value of non unique items. Additionally, for the benefit of an online retailer in combination with a traditional or online retailer, U.S. patent application Ser. No. 09/741,714 by Koulouris discloses a system for matching the marketing collateral of a subscriber business with the specific customer and item information of an online retailer.

Despite information technology developments, many traditional so-called brick-and-mortar small businesses have found little help in attracting customers. It is therefore desirable to create a practical information-technology tool that improves the operating environment for attracting customers specifically for traditional so-called brick-and-mortar small businesses.

### SUMMARY

With the desire to improve the operating environment for traditional so-called brick-and-mortar small businesses and other organizations, I have invented a Reciprocal Tangible-Promotional-Materials Presentations (RTPMP) enabling system. This invention was developed to meet many objectives including:
A.) To provide a technology tool for small businesses that does not require online customers;
B.) To provide a technology tool for small businesses that does not require the gathering or use of customer information;
C.) To provide a technology tool that does not require the design, development, input, update, or maintenance of a database of merchandise information;
D.) To provide traditional so-called brick-and-mortar small businesses and other organizations with a technology tool to enable and facilitate effective efforts for attracting consumers;
E). To provide a practical technology tool that can be broadly used by traditional so-called brick-and-mortar small businesses and other organizations;
F.) To provide a technology tool that enables low-cost promotions for organizations;
G.) To provide a technology tool that is easy to learn and use, and does not require learning, understanding, or agreeing to the terms of complicated business method schemes;
H.) To provide a technology tool that increases significantly the ability of organizations to reach consumers without having to purchase, develop, or maintain expensive lists, and without having to risk the liability associated with consumer privacy issues;
I.) To provide a technology tool that increases significantly the ability of organizations to present promotional materials to desired consumers in an affordable and non-intrusive manner, thus improving the overall operating environment for these organizations;
J.) To provide a technology tool that increases significantly the number and type of promotion possibilities for traditional so-called brick-and-mortar organizations;
K.) To provide a technology tool that allows organizations to use a low-cost and therefore low risk trail-and-error approach to gain promotion knowledge and client knowledge;
L.) To provide a technology tool that increases significantly the ability of organizations to gain knowledge through low cost promotional experimentation and exploration using a variety of promotion variables;
M.) To provide a technology tool that enables traditional businesses to reciprocally present tangible-promotional-materials without the need for online customers;
N.) To provide a technology tool that does not require expensive, electronic point of sale or point of shipping equipment, and that does not cause delays and undue complication at the point of sale or shipping;
O.) To provide a technology tool for simple, low-technology businesses that can be implemented in a low cost and efficient manner;
P.) To provide a technology tool that does not require an online retailer;
Q.) To provide a technology tool that specifically enables tangible-promotional-materials presentations in a reciprocal manner to greatly reduce costs associated with advertising;
R.) To provide a technology tool that is effective for businesses that offer a very limited set of products or services or that operate within a very limited geographical area.

These advantages offered from meeting each of these objectives along with other aspects and advantages of the present invention will be evident as details describing the present invention are presented here forth. In meeting each of these objectives to improve the overall operating environment for traditional so called brick-and-mortar small businesses and other organizations, my development efforts led to a computer system for enabling RTPMP among users of a computer network. The computer system comprises a data storage device for storing a plurality of RTPMP variables that together model potential RTPMP, and a processor coupled to the data storage device. The RTPMP variables have associated values. The processor is operative to perform a plurality of steps including the following. A first graphical user interface is provided to the users via the computer network. The first graphical user interface is characterized by a plurality of data inputs for structuring the input of RTPMP data corresponding to the RTPMP variables. The RTPMP data is accepted through the first graphical user interface from the users via the computer network to establish the values of the RTPMP variables for modeling the users for potential RTPMP. The RTPMP data is stored in the data storage device. A second graphical user interface is provided to a first user among the users via the computer network. The second graphical user interface is characterized by one or more inputs for candidate data for defining a model of a potential RTPMP candidate. The candidate data is accepted through the second graphical user interface from the first user via the computer network. The RTPMP data is compared to the candidate data of the users to obtain zero or more associated candidate-users among the users. RTPMP data associated with the candidate users is presented to the first user via the computer network for evaluation of potential RTPMP. If desired by the first user, communication between the first user and one of the candidate users is facilitated via the computer network to enable RTPMP.

Additionally, the present invention can be embodied as a method for enabling RTPMP among users of a communications network. The method comprises the following. RTPMP data is gathered from the users via the communications network for specifically characterizing potential RTPMP. The RTPMP data is stored in a data storage device. Users are allowed to manage and maintain currentness of the RTPMP data via the communications network. Requests are received from the users via the communications network for processed RTPMP-data to enable RTPMP among the users. The RTPMP data is processed according to the requests to obtain the requested, processed RTPMP-data. This requested, processed RTPMP-data is sent to the users via the communications network to enable the RTPMP among the users.

Additionally, the present invention can be embodied as a computer-readable medium containing instructions for enabling RTPMP among users of a computer network, wherein the instructions, when executed, comprise the following. A plurality of RTPMP variables are stored that together form a model of potential RTPMP among the users. The RTPMP variables have associated values. A first graphical user interface is provided to the users via the computer network. The first graphical user interface characterized by a plurality of data inputs for structuring the input of RTPMP data corresponding to the RTPMP variables. The RTPMP data is accepted through the first graphical user interface from the users via the computer network to define the values of the RTPMP variables, and thus establish actual instances of the RTPMP model. A second graphical user interface is provided to a first user among the users via the computer network. The second graphical user interface characterized by one or more inputs for data defining a prototype instance of the RTPMP model. The data defining a prototype instance of the RTPMP model is accepted through the second graphical user interface from the first user via the computer network. One or more second users among the users are selected which are associated with the defined prototype-instance of the RTPMP model. Data associated with the actual instances of the RTPMP model of the selected, one or more second users is presented to the first user for evaluation of potential RTPMP. If desired by the first user, a third graphical user interface is provided for creation and communication of a first RTPMP proposal from the first user to a third user among the one or more second users, wherein the first user is facilitated in selecting the RTPMP data complicit with the actual instance of the RTPMP model of the third user to enable creation of the first RTPMP proposal satisfactory to the third user. And, if desired by the third user, a fourth graphical user interface is provided for creation and communication of a second RTPMP proposal from the third user to the first user, wherein the third user is facilitated in selecting the RTPMP data complicit with the actual instance of the RTPMP model associated with the first user to enable creation of the second RTPMP proposal satisfactory to the first user.

Yet another embodiment of the present invention is a method for enabling RTPMP among users of computer network comprising the following. A first graphical user interface is provided to the users via the computer network. The first graphical user interface is characterized by a plurality of data inputs for structuring the input from the users via the computer network of RTPMP data characterizing RTPMP. The RTPMP data is accepted through the first graphical user interface from the users via the computer network. The RTPMP data is stored in a data storage device. A second graphical user interface is provided to a first user among the users via the computer network. The second graphical user interface characterized by one or more inputs for candidate data for defining a potential RTPMP candidate. The candidate data is accepted through the second graphical user interface from the first user via the computer network. The candidate data is compared to the RTPMP data of the users to obtain zero or more associated candidate-users among the users. The RTPMP data associated with the candidate users is presented to the first user via the computer network for evaluation of potential RTPMP. If desired by the first user, a third graphical user interface is provided for creation and communication of a first RTPMP proposal from the first user to a first candidate-user among the candidate users, wherein the first user is facilitated in selecting RTPMP data associated with the first candidate-user to enable creation of the first RTPMP proposal satisfactory to the first candidate-user. And, if desired by the first candidate-user, a fourth graphical user interface is provided for creation and communication of a second RTPMP proposal from the first candidate-user to the first user, wherein the first candidate-user is facilitated in selecting RTPMP data associated with the first user to enable creation of the second RTPMP proposal satisfactory to the first user.

### BRIEF DESCRIPTION OF THE DRAWINGS

These and other features, aspects, and advantages of the present invention will become better understood with regard to the following description, appended claims, and accompanying drawings where:

FIG. 1 illustrates the RTPMP enabling system.

FIG. 2 illustrates a reciprocal tangible-promotional-materials presentation.

FIG. 3 illustrates another reciprocal tangible-promotional-materials presentation.

FIG. 4 illustrates yet another reciprocal tangible-promotional-materials presentation.

FIG. 5 illustrates a RTPMP data gathering process provided by the RTPMP enabler.

FIG. 6 illustrates a RTPMP enabling service provided by the RTPMP enabler.

FIG. 7 illustrates a RTPMP management service provided by the RTPMP enabler.

FIG. 8 illustrates the value created from utilization of the RTPMP enabling system.

FIG. 9 illustrates the preferred embodiment of the RTPMP enabling system.

FIG. 10 illustrates the operation of the preferred embodiment of the RTPMP enabling system.

FIG. 11 illustrates the services provided by the RTPMP enabling website.

FIG. 12 illustrates the six stages of the RTPMP enabling website.

FIG. 13 illustrates the five categories of data gathered from new users.

FIGS. 14-23 illustrate forms for input of entity characteristics data.

FIGS. 24-25 illustrate forms for input of presentation data.

FIGS. 26-28 illustrate forms for input of TPM data.

FIGS. 29-30 illustrate forms for input of presentation data.

FIG. 31 illustrates a form for input of TPM data.

FIGS. 32-34 illustrate forms used in the reciprocator choice stage.

FIGS. 35-38 illustrate forms used in the RTPMP proposal stage.

FIG. 39 is a diagram that illustrates the RTPMP proposal process.

FIG. 40 illustrates a form for generating an open proposal.

FIG. 41 illustrates a form for creating and sending confirmations.

FIG. 42 illustrates a form for input of user feedback.

FIGS. 43-45 illustrate forms used in the RTPMP management stage.

FIGS. 46-47 illustrate TPM and their associated presentations.

### DESCRIPTION

In general, methods and systems consistent with the present invention enable Reciprocal Tangible-Promotional-Materials Presentations (RTPMP) among a plurality of entities. Individuals associated with the entities receive the presentations. In more detail, preferred systems and methods of the present invention electronically enable RTPMP among a plurality of entities.

RTPMP Enabling System

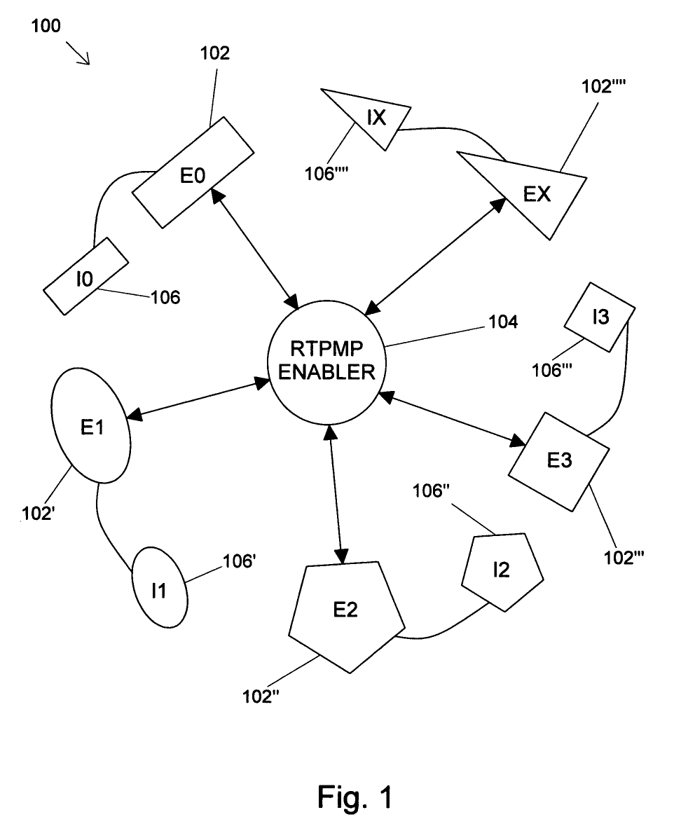

FIG. 1 provides a general illustration of the RTPMP enabling system 100 of the present invention. Referring to FIG. 1, a plurality of disparate entities 102-102″″ (namely, entities E0-EX; where X is a number greater than 3) seeking to become electronically RTPMP enabled are electronically serviced by a RTPMP enabler 104. The entities E0-EX have associated individuals 106-106″″ (namely, individuals I0-IX respectively).

RTPMP

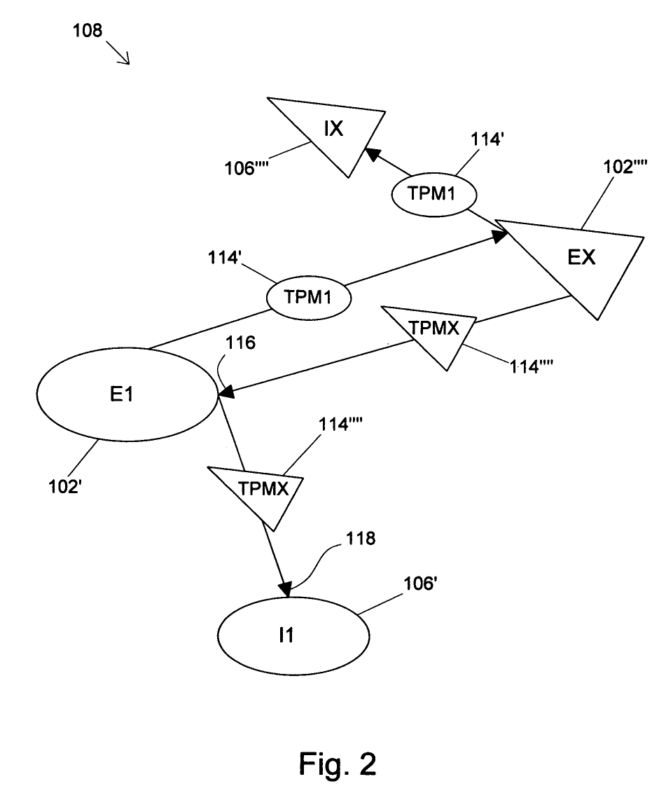

Each of the entities (E0-EX) is willing to suitably present Tangible Promotional Materials (TPM) of another entity or entities to their own associated individuals (I0-IX respectively), if a suitable TPM presentation is made in a reciprocal manner on their behalf by another entity or entities. Examples 108, 110, and 112 of these reciprocal TPM presentations are shown in FIGS. 2 through 4 respectively.

Referring to FIG. 2 for presentation example 108, entity E1 102′may receive 116 and subsequently present 118 the TPM 114″″ of entity EX (namely, TPMX) to its own associated individuals I1 106′; and in a reciprocal manner, entity EX 102″″ may receive and subsequently present the TPM 114′ of entity E1 (namely, TPM1) to its associated individuals IX 106″″.

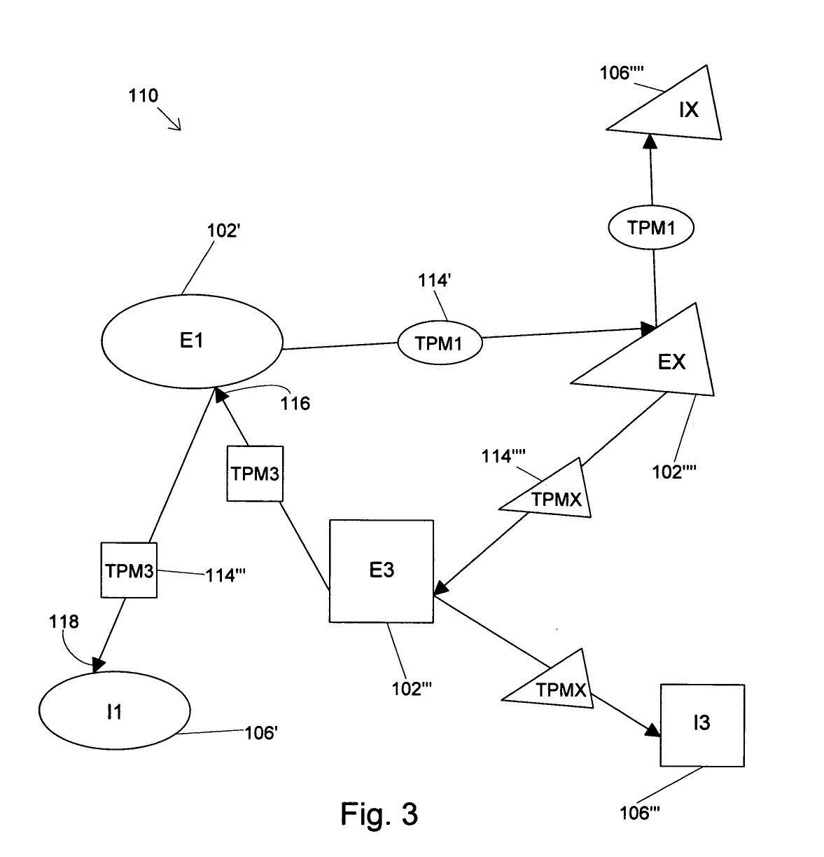

Referring to FIG. 3 for another presentation example 110, entity E1 may receive 116 and subsequently present 118 the TPM 114′″ of entity E3 (namely, TPM3) to its own associated individuals I1; entity EX may receive and subsequently present the TPM of entity E1 (namely, TPM1) to its own associated individuals IX; and entity E3 102′″ may receive and subsequently present the TPM of entity EX (namely, TPMX) to its own associated individuals I3 106′″. Thus, each entity presents TPM of another entity and has its own TPM presented in a reciprocal manner by another entity in a three-entity configuration.

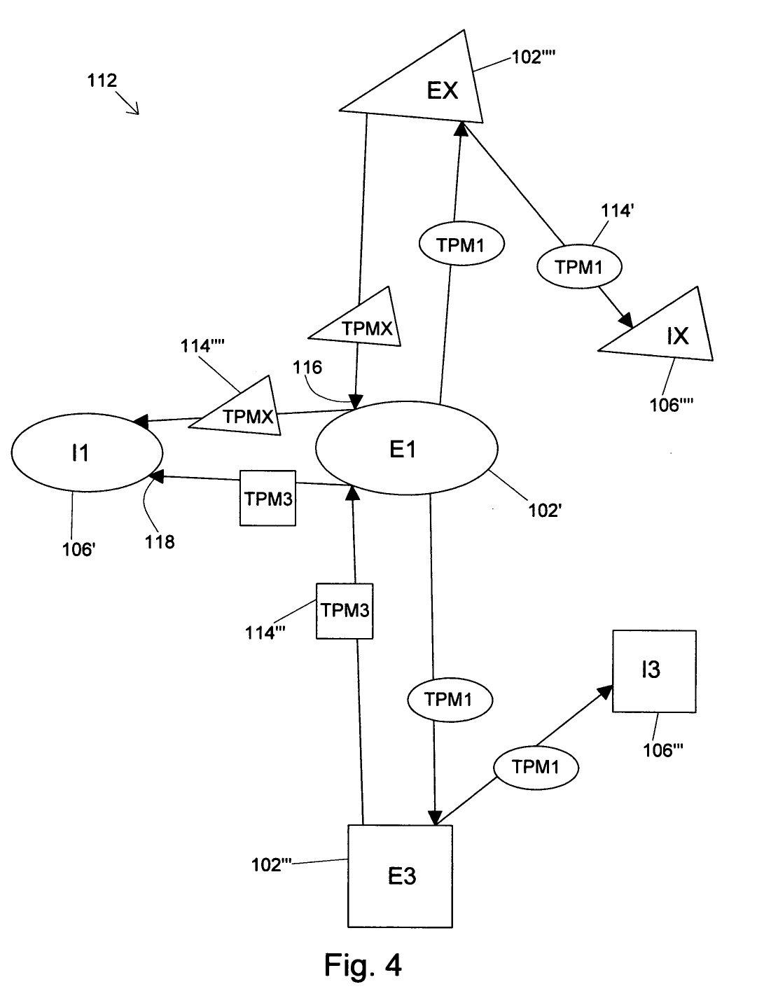

Referring to FIG. 4 for yet another presentation example 112, entity E1 may receive 116 and subsequently present 118 the TPM of entities E3 (namely, TPM3) and EX (namely, TPMX) to its own associated individuals I1; and in a reciprocal manner, entities EX and E3 may receive and subsequently present the TPM of entity E1 (namely, TPM1) to their own associated individuals I3 and IX.

RTPMP Enabling Services

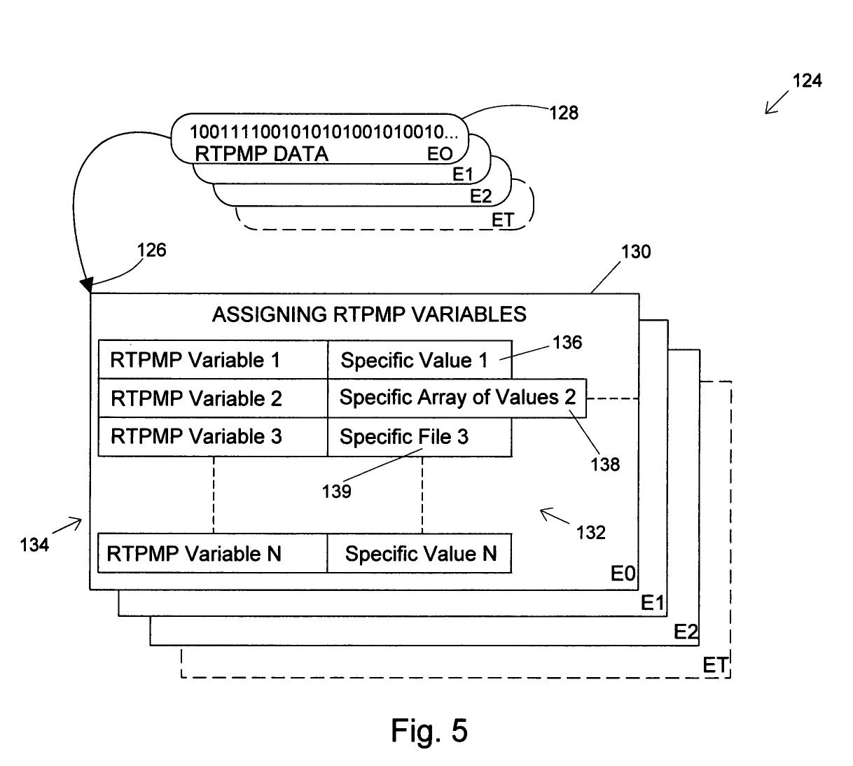

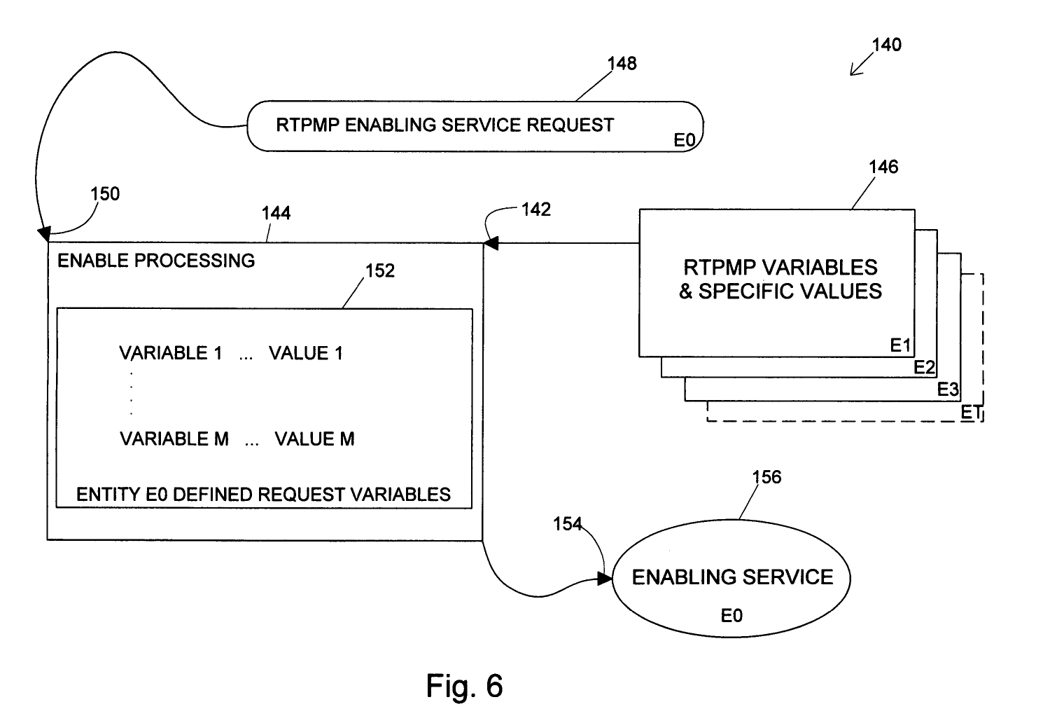

To enable RTPMP, the RTPMP enabler provides electronic enabling services to the entities. Electronic enabling services include RTPMP data gathering, storage, processing, and communication. FIGS. 5 and 6 illustrate these services.

FIG. 5 illustrates a service 124 of receiving RTPMP data and assigning RTPMP variables for each entity. Referring to FIG. 5, the RTPMP enabler electronically receives 126 RTPMP data 128 from each of the entities E0-ET (where T is the total number of entities). This data is used to assign 130 specific values 132 to RTPMP variables 134 associated with each entity. The specific values can include single specific values 136, arrays of specific values 138, and specific files 139.

FIG. 6 illustrates a service 140 of providing RTPMP-enabling data processing. The RTPMP enabler electronically services an entity by accessing 142 and processing 144 RTPMP variables and their associated specific values 146 according to an RTPMP enabling service request 148 that is received 150 from the entity. In this illustration, the requesting entity is entity E0. Processing is guided by user-defined request variables 152 that are received in the RTPMP enabling service request. Processed, RTPMP enabling data is then electronically sent 154 to the requesting entity to complete the RTPMP enabling service 156. With these enabling services, entities are able to initiate and complete RTPMP.

RTPMP Management Services

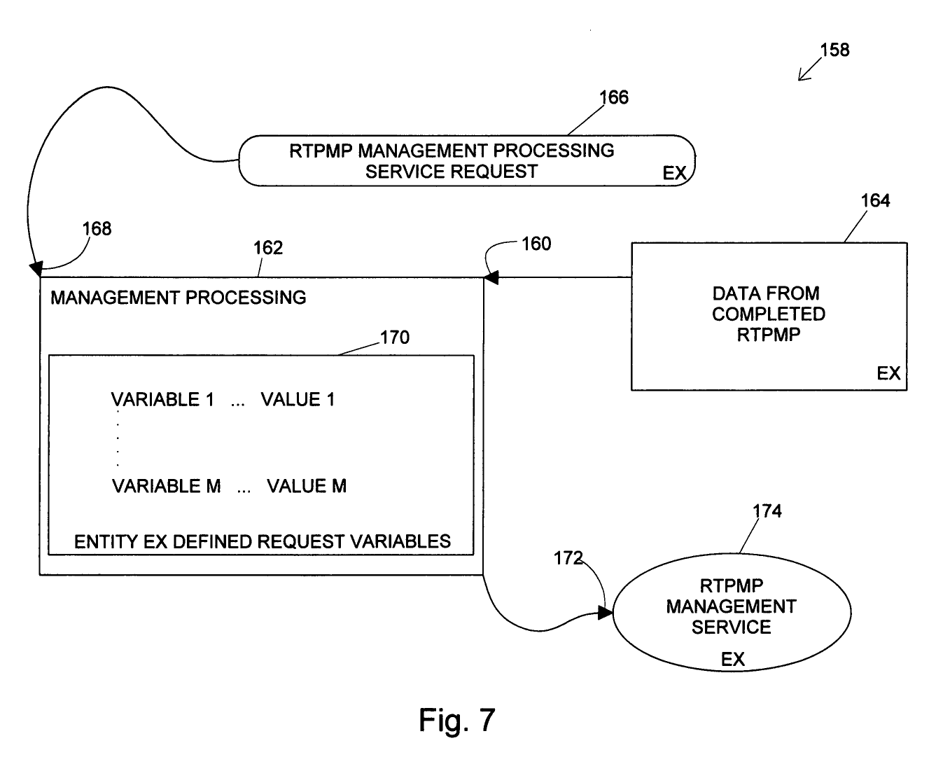

As RTPMP are completed, data from the completed RTPMP is stored in a database. To manage this growing database, the RTPMP enabler can service the entities as an RTPMP manager. FIG. 7 illustrates a process 158 of providing a RTPMP management processing service. The RTPMP manager electronically services the entities by accessing 160 and processing 162 stored data from completed RTPMP 164 according to RTPMP management service requests 166 that are received 168 from the entities. Processing is guided by user-defined request variables 170 that are received in the RTPMP management service request. Processed, RTPMP management data is then electronically sent 172 to the requesting entity to complete the RTPMP management service 174. RTPMP management services include storage, editing, display, and analysis of data from completed RTPMP.

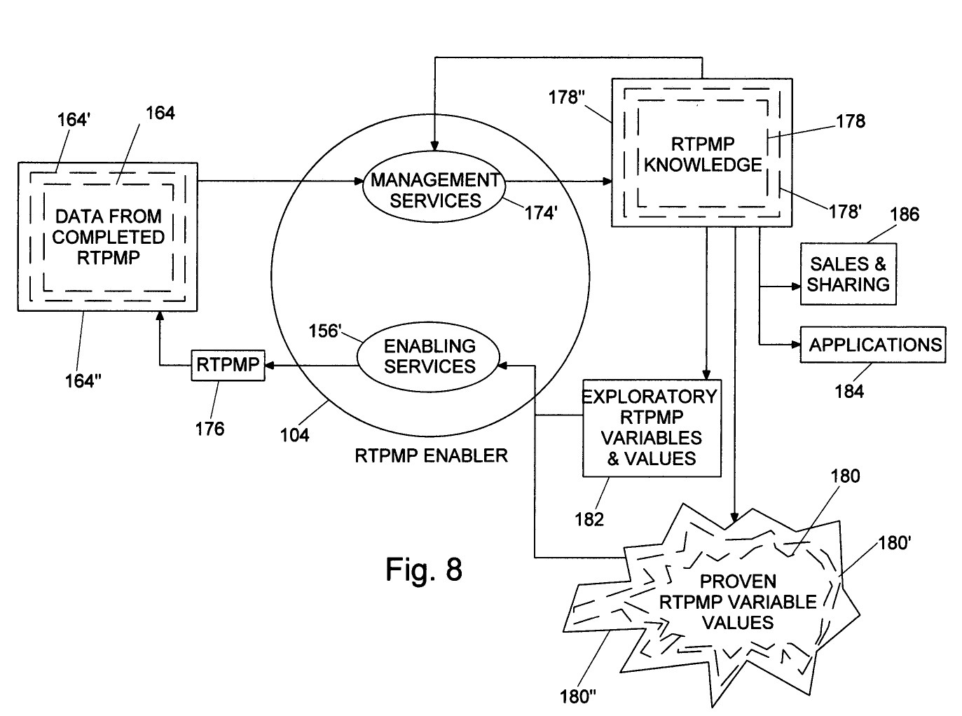

Value Inherently Created From Utilization of RTPMP Enabling System Referring to FIG. 8, as RTPMP 176 are completed, data from the completed RTPMP 164 is stored in a database. By utilizing management analysis services 174′, an entity gains RTPMP knowledge 178 from this data. This knowledge can be used to determine proven RTPMP-variable values 180 for future RTPMP, and used to determine exploratory RTPMP variables and their associated specific values 182 for future RTPMP. After these future RTPMP are completed through utilization of the enabling services 156′ of the RTPMP enabler 104, additional data from these completed RTPMP is stored in the database.

As this cycle is repeated, growth occurs in the data from completed RTPMP, in the RTPMP knowledge, and in the proven RTPMP variable values. This growth is illustrated as the data from completed RTPMP grows from 164 to 164′; thereby causing the RTPMP knowledge to grow from 178 to 178′; thereby causing the proven RTPMP variable values to grow from 180 to 180′; thereby causing data from completed RTPMP to grow from 164′ to 164″; thereby causing the RTPMP knowledge to grow from 178′ to 178″; thereby causing the proven RTPMP variable values to grow from 180′ to 180″, and so on.

This cycle of growth occurring from utilization of the RTPMP enabling system inherently creates value for the entities. For example, value from this RTPMP knowledge can be realized in many ways including the following five ways. First, as mentioned above, this knowledge can be used to determine proven RTPMP variable values for future RTPMP. Second, as mentioned above, this knowledge can be used to determine exploratory RTPMP variables and their associated specific values for future RTPMP. Third, this knowledge can be fed back to improve the management services. Fourth, this knowledge can be applied to other applications 184 such as other promotional activities of the entity. Fifth, this knowledge can be reciprocally shared with other users or sold 186.

### DETAILED DESCRIPTION OF PREFERRED EMBODIMENT

RTPMP System

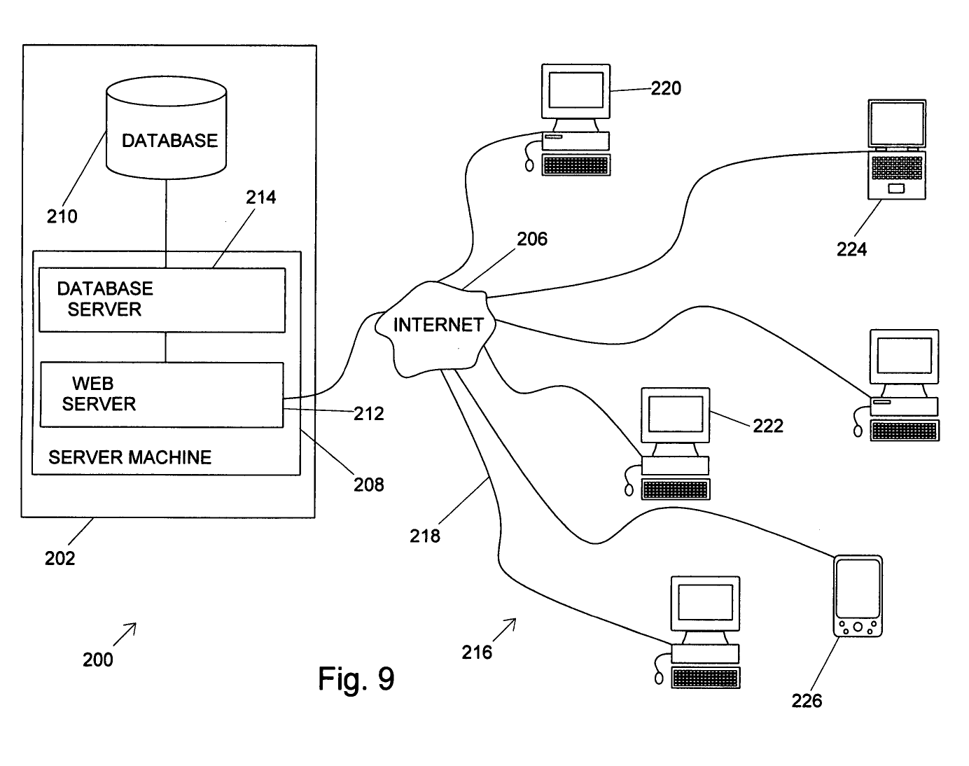

FIG. 9 illustrates the preferred embodiment 200 of the RTPMP enabling system 100 (FIG. 1). In this preferred embodiment 200, the RTPMP enabler 104 (FIG. 1) comprises a platform 202 for operating a website available via the global Internet 206 communications network known as the World Wide Web. The website provides services to enable RTPMP and RTPMP management services. The platform 202 comprises a server machine 208, and a database 210. The server machine comprises a web server 212, and a database server 214.

Continuing to describe the preferred embodiment with FIG. 9, the entities 102-102″″ (FIG. 1) comprise users 216 of the RTPMP website. Users access the enabling services of the RTPMP website via an Internet connection 218 while operating web browser software on a personal computer 220, workstation 222, laptop computer 224, PDA 226, or the like. Connections to the Internet are commonly provided by telephone companies, cable television companies, and Internet service providers.

Users include any entity willing to participate in Reciprocal Tangible-Promotional Materials-Presentations (RTPMP). For example, users may include small businesses, groups having members, government organizations, non-profit organizations, manufactures, wholesalers, retailers, service providers, product providers, and organizations.

Accordingly, the individuals 106-106″″ (FIG. 1) comprise people who are associated with the users and who are willing to receive Tangible Promotional Materials (TPM). For example, these people include customers of a business; employees of a business, a government, or an organization; citizens served by a government organization, associates of a business, members of a group, donors of a non-profit organization, and organization members.

RTPMP

Referring again to FIGS. 2-4, in the preferred embodiment the entities 102-102″″ comprise users of the RTPMP website, and the individuals 106-106″″ comprise people associated with the users. For example in FIG. 2, entity E1 could be a pizza restaurant and entity EX could be a car wash. Accordingly, individuals I1 would be people associated with the pizza restaurant, and individuals IX would be people associated with the car wash. For the pizza restaurant, these people could be, for example, customers or employees, and likewise for the car wash.

Using the enabling services of the RTPMP website, the car wash and the pizza restaurant may enable reciprocal presentations such as those show in FIG. 2. Thus, the pizza restaurant (represented by E1) could arrange delivery of its pizza coupons (represented by TPM 1) to the car wash (represented by EX), and the car wash could arrange delivery of its car wash advertisements (represented by TPM X) to the pizza restaurant. The pizza restaurant would subsequently present the car wash advertisements to its customers (represented by I1), and in a reciprocal manner, the car wash would present the pizza restaurant coupons to its customers (represented by IX).

In the preferred embodiment, presentations include distribution of TPM to the associated people, and display of TPM to the associated people. Tangible Promotional Materials (TPM) include materials intended for distribution and materials intended for display. Examples of materials intended for distribution include brochures, coupons, catalogs, flyers, advertisements, business cards, product samples, and promotional merchandise such as pens, buttons, key chains, and refrigerator magnets. Examples of materials intended for display include banners, signs, countertop displays, and floor displays.

Operation of RTPMP System

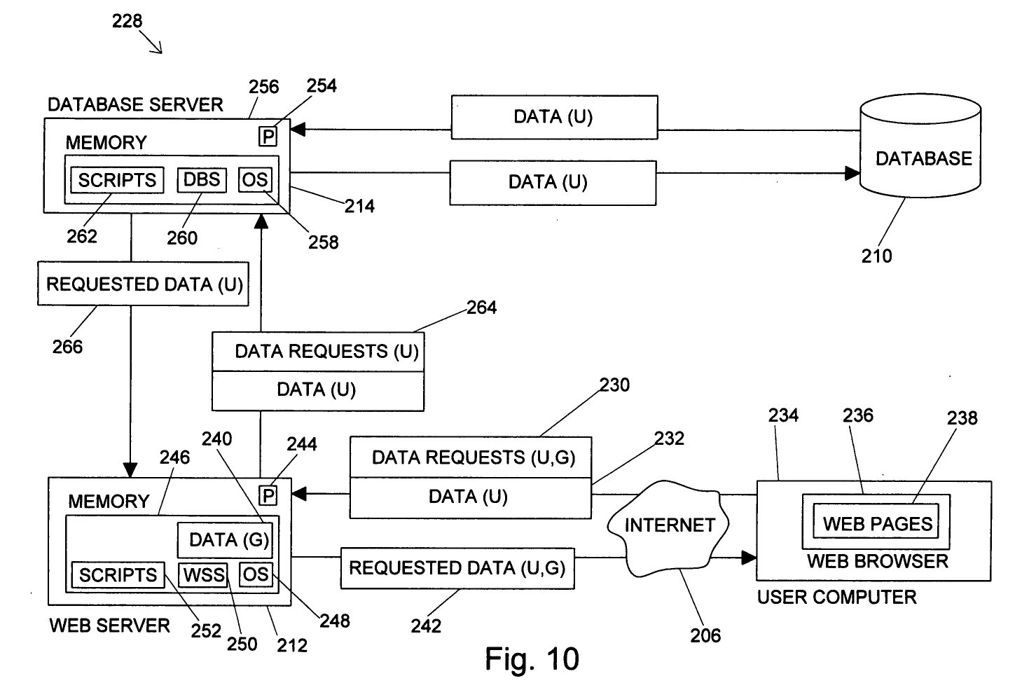

FIG. 10 illustrates the operation 228 of the website platform. The web server 212 receives data requests 230 and user data (U) 232 from a user computer 234 via the Internet 206. The data requests include requests for general data (G) 240, and user data (U). The user data (U) is also referred to as RTPMP data. The web server processes the requests and sends the requested data 242 to the user computer via the Internet. The web browser 236 operating on the user computer displays the requested data as a web page 238. A uniform resource locator specifies the web site.

General data (G) refers to all data that is not specific to a user but rather common among users, such as registration forms and website graphics. This general data (G) is stored in a memory storage device of the web server for efficient operation.

User data (U) refers to all data that is specific to a user, such as geographic locations, passwords, and data from completed RTPMP. User data (U) is stored in the database.

The web server comprises a processor 244 coupled to a memory storage device 246. The memory storage device (e.g., RAM or hard drive) contains an operating system 248, web server software 250, and scripts 252 for providing the user data (U) and general data (G) content of the web pages to user computers.

The database server comprises a processor 254 coupled to a memory storage device 256. The memory storage device (e.g., RAM or hard drive) contains an operating system 258, database software 260 and associated scripts 262 for the particular database structures and processing needed to store and provide the user data (U) content of the web pages to the web server.

The web server processes requests for general data (G) by accessing the general data (G) in its memory storage device and sending it to the user computer via the Internet.

Users input user data (U) into forms provided by the web server. Form inputs define RTPMP variables to which the user data (U) is assigned. The RTPMP variables and their assigned user data (U) are sent to the web server, which sends them to the database server. The database server stores the RTPMP variables and their assigned user data (U) in the database for each unique user.

The web server processes requests for user data (U) and sends the requests to the database server. These user data (U) requests contain request variables and their defined values, which are input into forms by the requesting user. These request variables and their defined values determine which data is accessed from the database and how the data is processed.

The database server receives the requests for user data (U) 264, and guided by the request variables and their defined values, the database server subsequently accesses and processes data from the database. The resulting, requested user data (U) 266 is then sent to the web server, which sends the user data (U) to the user computer via the Internet.

Each web page comprises general data (G) or a combination of general data (G) and user data (U). Together, these web pages comprise the website.

Website

As illustrated in FIG. 11, the RTPMP website 204 provides RTPMP enabling services 268, and RTPMP management services 270.

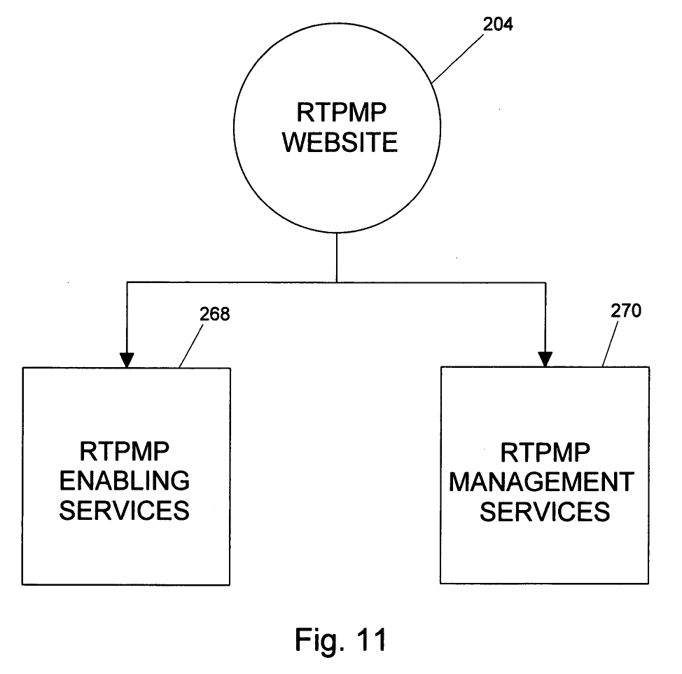

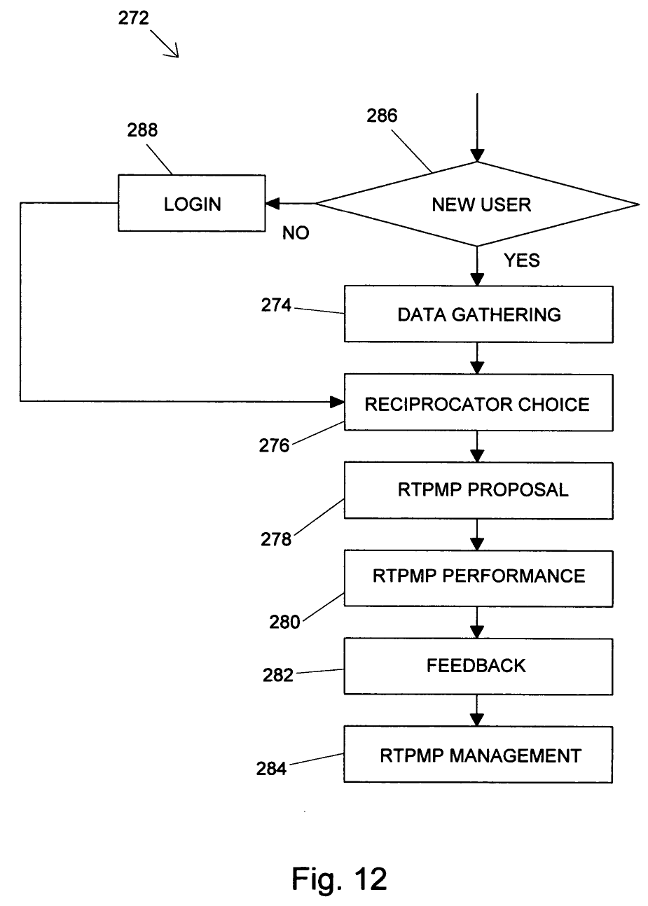

FIG. 12 illustrates the general operation 272 of the website. The website generally operates in six stages. These stages include an RTPMP data gathering stage 274, a reciprocator choice stage 276, an RTPMP proposal stage 278, an RTPMP performance stage 280, an RTPMP management stage 282, and a feedback stage 284. As shown in FIG. 12, after an initial decision 286, new users are sent to the data gathering stage to complete registration, while registered users are sent to login 288 to bypass registration. The remaining stages are listed from top to bottom in order of occurrence in typical RTPMP.

RTPMP Data Gathering Stage

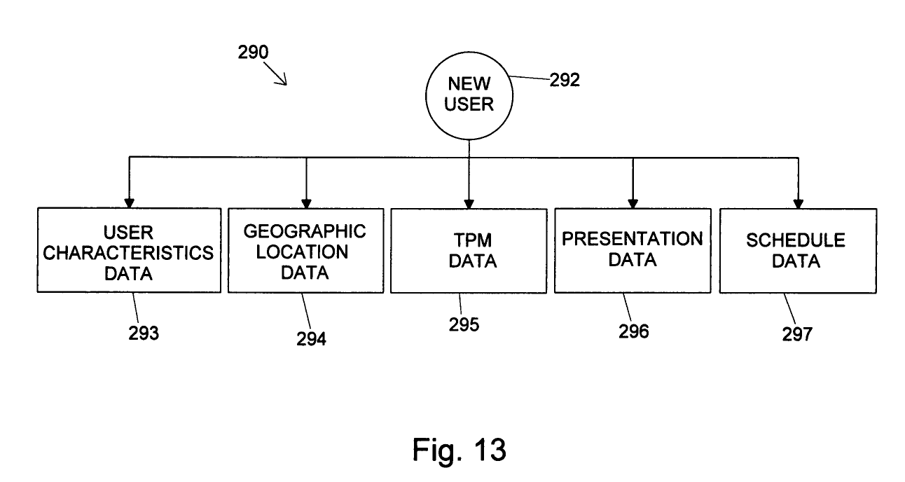

The first stage is the RTPMP data gathering stage. An illustration 290 of the data gathering stage is shown in FIG. 13. User data (U) is gathered from each new user 292 for registration. This user data (U) includes user characteristics data 293, geographic location data 294, TPM data 295, presentation data 296, and schedule data 297. Users input user data (U) into forms. Form inputs define RTPMP variables (also referred to as data variables) to which the user data (U) is assigned. The RTPMP variables and their assigned data are stored as in the database. Together the RTPMP variables provide a model of potential RTPMP among the users and the user data (U) provides actual instances of the RTPMP model.

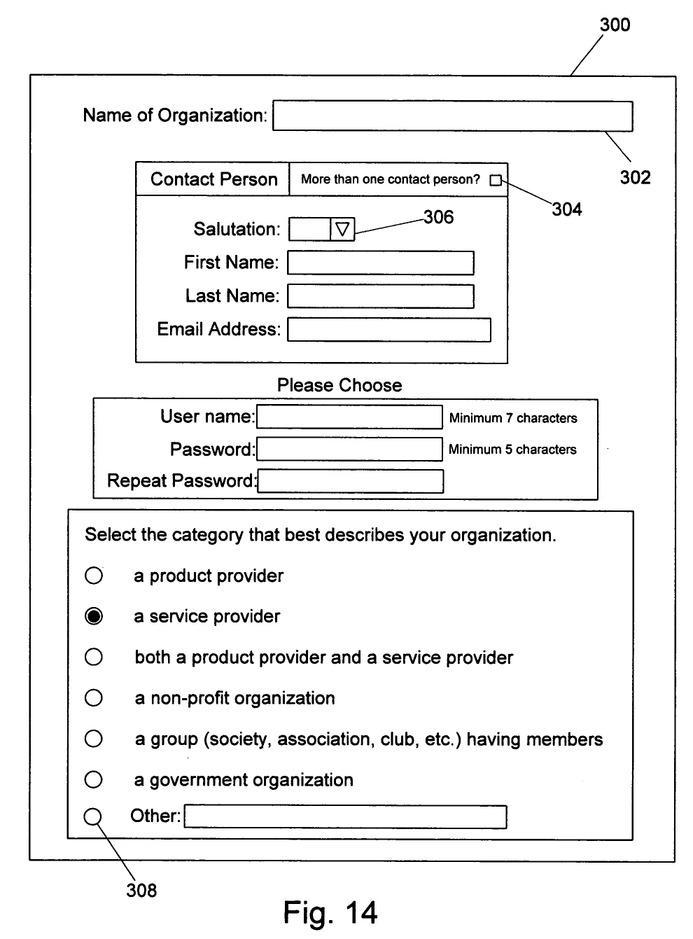

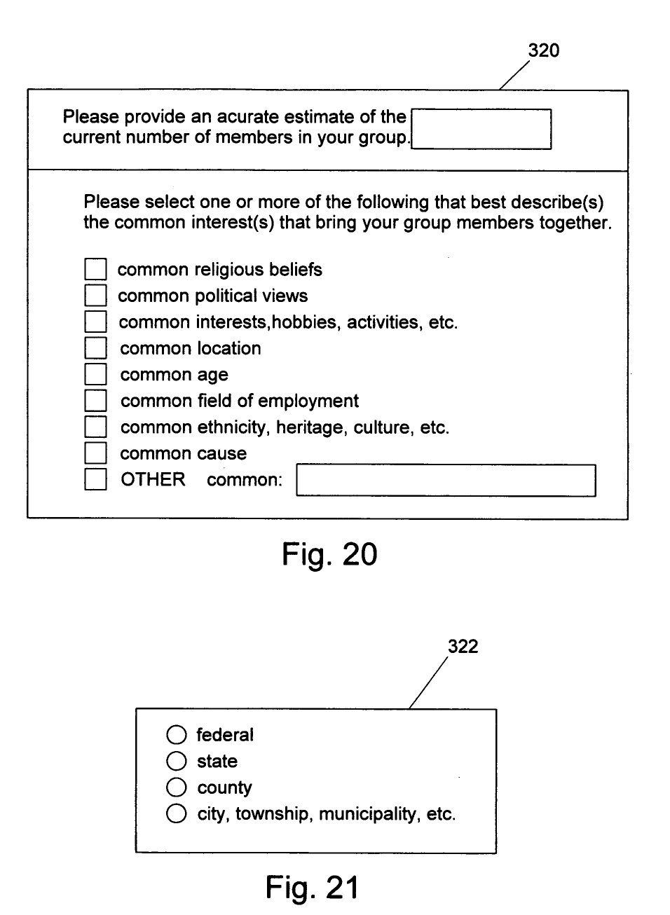

User characteristics data is gathered from each user. User characteristics data includes user identity data, and user categorization data. User identity data serves to identify each unique user. User categorization data serves to classify each unique user. Typical user characteristics data gathered is shown in FIGS. 14-22.

FIG. 14 illustrates a form 300 for accepting input of user characteristics data. The form includes user identity data inputs: name of organization, contact person information, and choice of user name and password. The form also includes categorization data inputs. Form inputs include text box 302, check box 304, pull down list 306, and radio buttons for selecting a category 308.

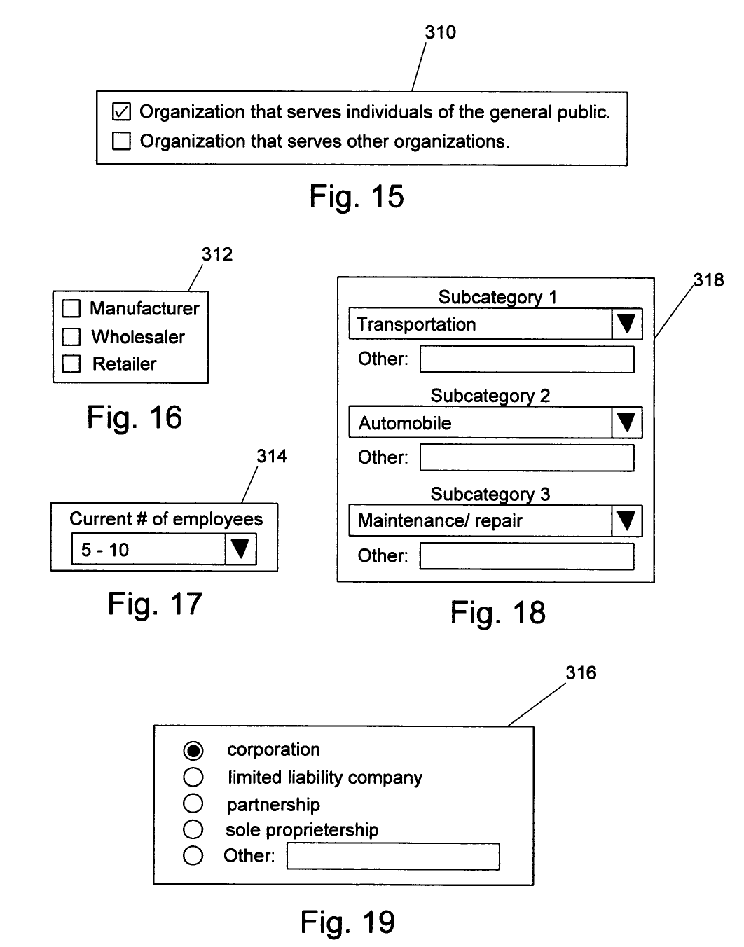

FIGS. 15-21 illustrate examples of additional forms for accepting input of user categorization data. Depending on the category selection made in form 300, a user may be asked to fill out one or more of the forms shown in FIGS. 15-21. Forms 310-318 are used if a product provider selection is made in form 300. Forms 310, and 314-318 are used if a service provider selection is made in form 300. Forms 314-318 are used if the non-profit selection is made in form 300. Form 320 is used if the group selection is made in form 300. Forms 314 and 322 are used if the government organization selection is made in form 300.

FIG. 19 illustrates a form 318 for accepting subcategory inputs. The choices offered in the subcategory 1 pull down list depend on the category selection in form 300. This dependence is followed for the remaining subcategories. As many subcategories are used as are needed to reach a suitable overall categorization of a given user. Thus, not all the subcategory lists need to be utilized for a given user.

For example, if the non-profit organization selection is made in form 300, subcategory 1 then includes such selections as children, women, arts, wildlife/animals, environment, minorities, poverty/hunger, consumer rights, health medical, government oversight, lifestyle choices, family/parenting, housing/homeless, fundraising, democracy, volunteering/community service, disaster relief, conservation, addictions, senior citizens, veterans, and other.

If, for example, the addictions selection was chosen from this pull down list, the sub category 2 pull down list then includes such selections as alcohol, prescription drugs, illegal drugs, gambling, all of the above, and other.

If no suitable choice is listed in a pull down list, the user chooses “other” and types a proper subcategory in the text box labeled other. If a text box labeled other is used, the remaining subcategory pull down lists are disabled.

Even if “other” is not selected, not all subcategory lists need to be utilized. Returning to the example above, if one of the selections (alcohol, prescription drugs, illegal drugs, gambling, and all of the above) is selected in the subcategory 2 pull down list, the subcategory 3 pull down list is disabled. In this case, a suitable subcategory has been reached using only the subcategory 2 pull down list and therefore subcategory 3 is not needed.

It is preferred that categories and subcategories be dynamic to suite the changing needs of users. As the text box labeled other is used, multiple instances of an entry should be taken as an indication to include the entry as a category or subcategory selection (which ever is appropriate). Also, if a category or subcategory selection is rarely or never used, it should considered for removal from the selection list. Also, the selections, categories, and sub categories should be continuously evaluated and adjusted to reflect the changes seen in organizations around the world. In this way, the selections, categories, and subcategories are dynamic to meet the changing needs of the users.

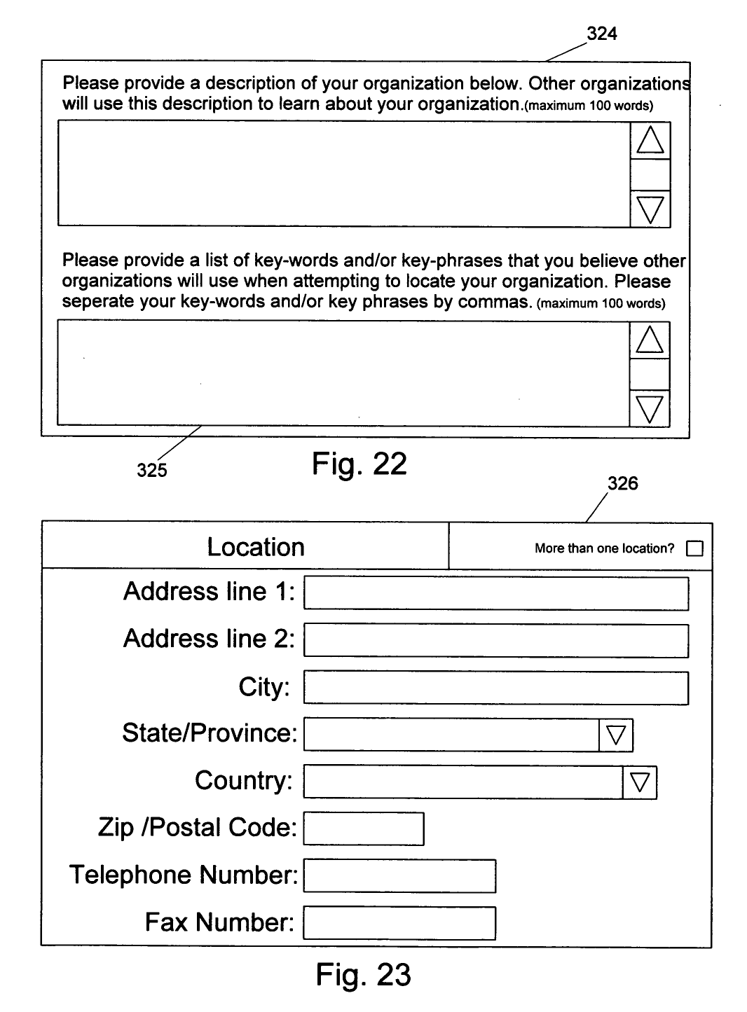

FIG. 22 illustrates a form 324 used for input of a description and keywords/key phrases into text areas 325. Other users read the description in the reciprocator choice stage, and the proposal stage. The keyword/key phrase input allows users to list words and/or phrases that will likely be used to find their organization without having to incorporate these words and phrases into the description.

The geographic location data gathered from each user provides other users with information needed to determine suitability of presentations and information needed for the delivery of TPM including calculation of delivery time and costs. FIG. 23 illustrates a form 326 for input of geographic location data. The form 326 provides a check box for organizations having multiple locations. If this check box is selected, additional forms 326 are made available for each of the locations.

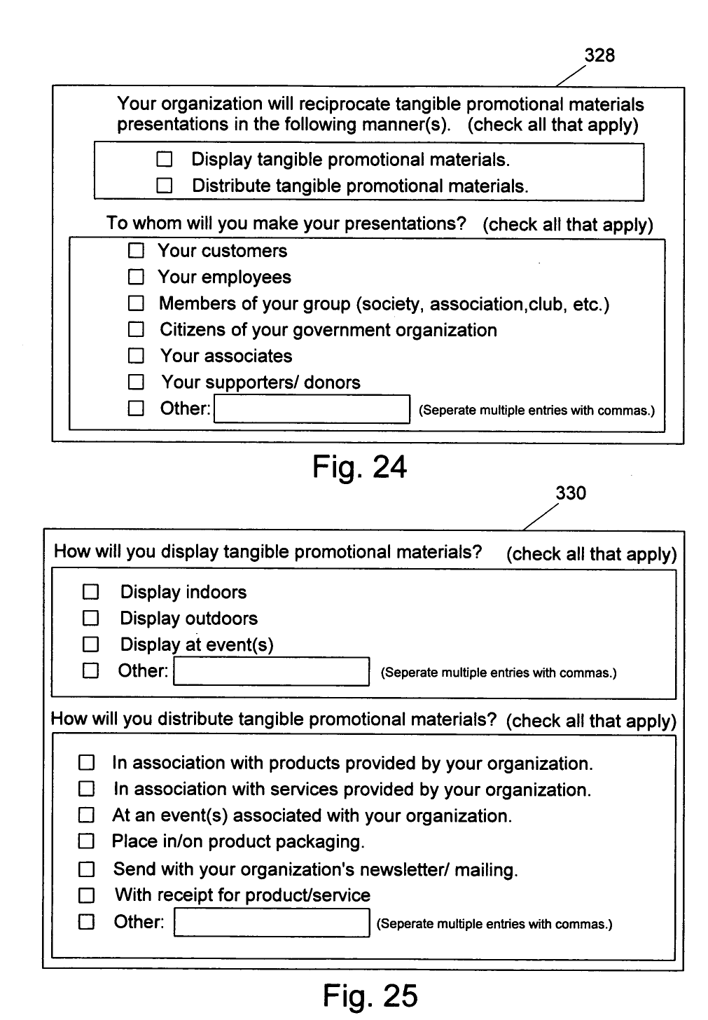

The presentation data gathered from the each user provides other users with information concerning the kind of presentations the user is willing to perform. FIGS. 24 and 25 illustrates forms for input of presentation data. Form 328 includes choices for type of presentations and choices for presentation recipients. Form 330 includes choices for display methods and choices for distribution methods.

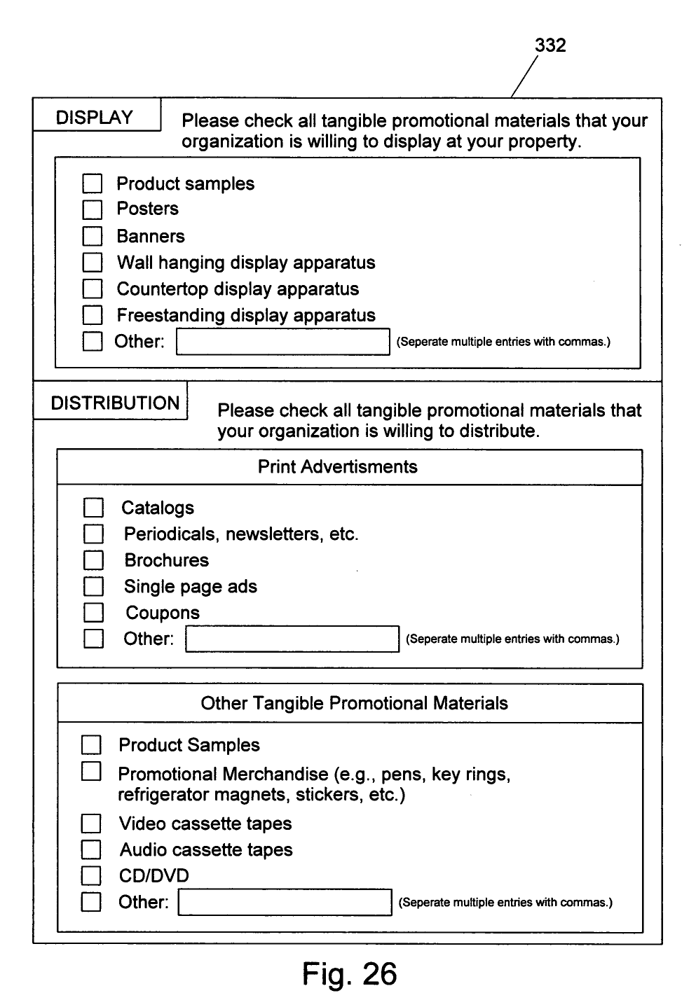

The TPM data gathered from each user provides other users with information concerning the kinds of TPM the user is willing to present. FIG. 26 illustrates a form 332 for input of TPM data. Form 332 includes choices for display of TPM and choices for distribution of TPM.

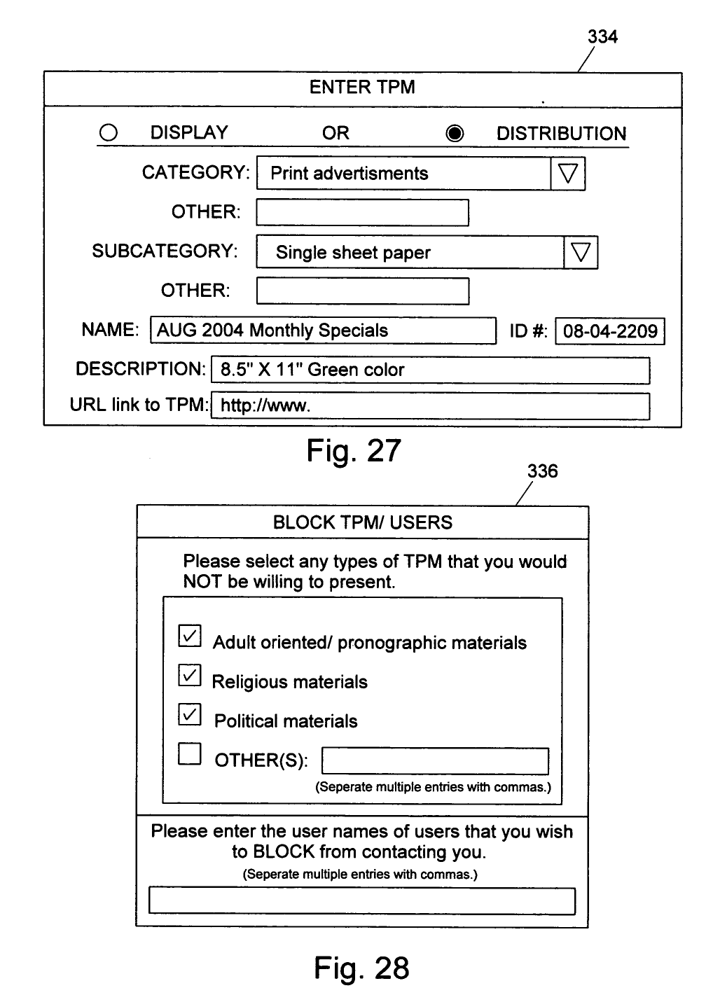

Additional TPM forms are shown in FIGS. 27 and 28. Form 334 is used to input TPM that a user will seek to have presented on their behalf by other users. Form 334 includes category and subcategory inputs to organize TPM. The form also includes an input for a link to an online version of the TPM for inspection and approval by other users. Form 336 is used to block TPM and users. Form 336 allows users to select and input the types of TPM they do not wish to present and input users they wish to block from contacting them.

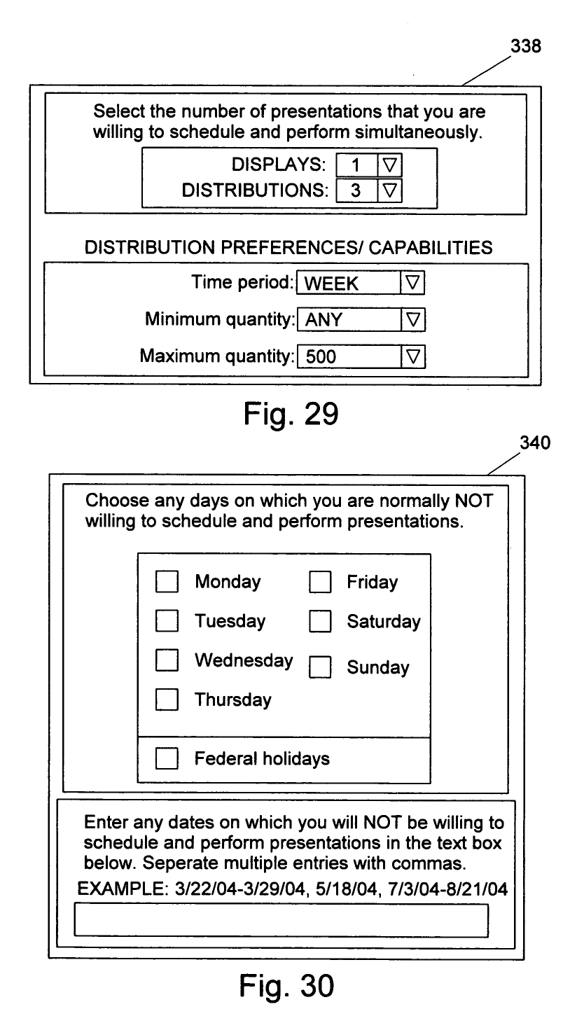

FIG. 29 illustrates a form 338 for input of additional presentation data. Form 338 includes selection lists for number of simultaneous displays and distributions, and selection lists for distribution preferences/capabilities.

The schedule data gathered from each user provides other users with information concerning RTPMP scheduling. The schedule data allows other users to coordinate RTPMP. FIG. 30 illustrates a form 340 for input of schedule data. Form 340 includes choices for days on which presentations will not be scheduled and performed and a text box for input of dates on which the user does not wish to schedule and perform presentations.

As shown above in form 338, the presentation data gathered includes the preferred maximum number of simultaneous presentations. This type of presentation data is used in conjunction with schedule data to inform other users if RTPMP can be scheduled with a particular user at a given time.

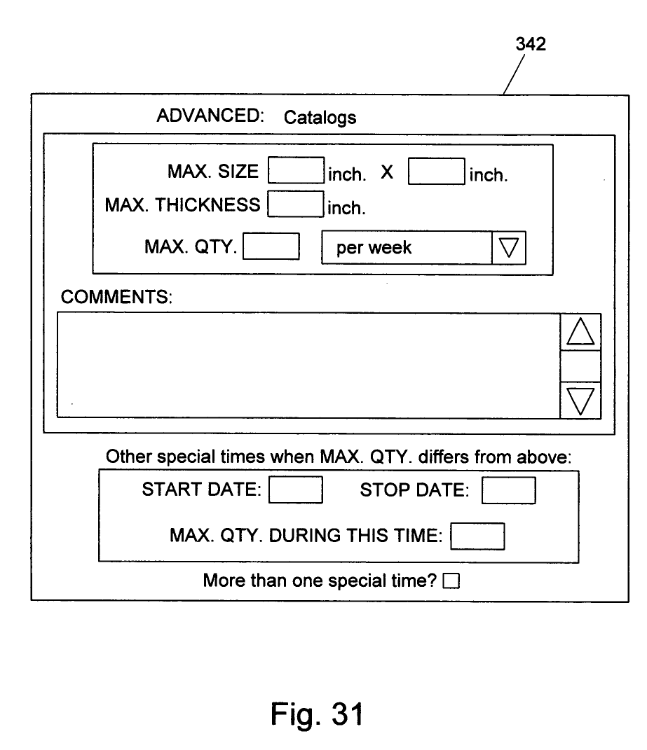

Some users may wish to provide more detailed information concerning the TPM that they would be willing to present. For example, FIG. 31 illustrates a form for more detailed input of TPM data for catalogs. Form 342 includes detailed size inputs and detailed inputs for maximum quantities. Similar forms containing details inputs are used for other types of TPM.

It is preferred that the data gathering stage described above be dynamic to suite the changing needs of users of the RTPMP system. Over time, changes occur in the type, size, and nature of organizations in the world. To meet the needs of these ever changing organizations, the type and amount of user data (U) gathered should be continuously evaluated and adjusted. This preferred dynamic approach insures the RTPMP system can meet the changing needs of users.

Reciprocator Choice Stage

The second stage is the reciprocator choice stage. In this stage, a user chooses one or more other users for RTPMP. Choices are made after reviewing user data (U) from selected users. These selected users are referred to as candidate users. These candidate users are found by providing specific values of query request variables to the database server to guide query processing of user data (U) stored in the database. Users assign specific values to query request variables using form inputs. The specific values of query request variables are referred to as candidate data. The candidate data defines a prototype instance of the RTPMP model for defining a potential RTPMP candidate.

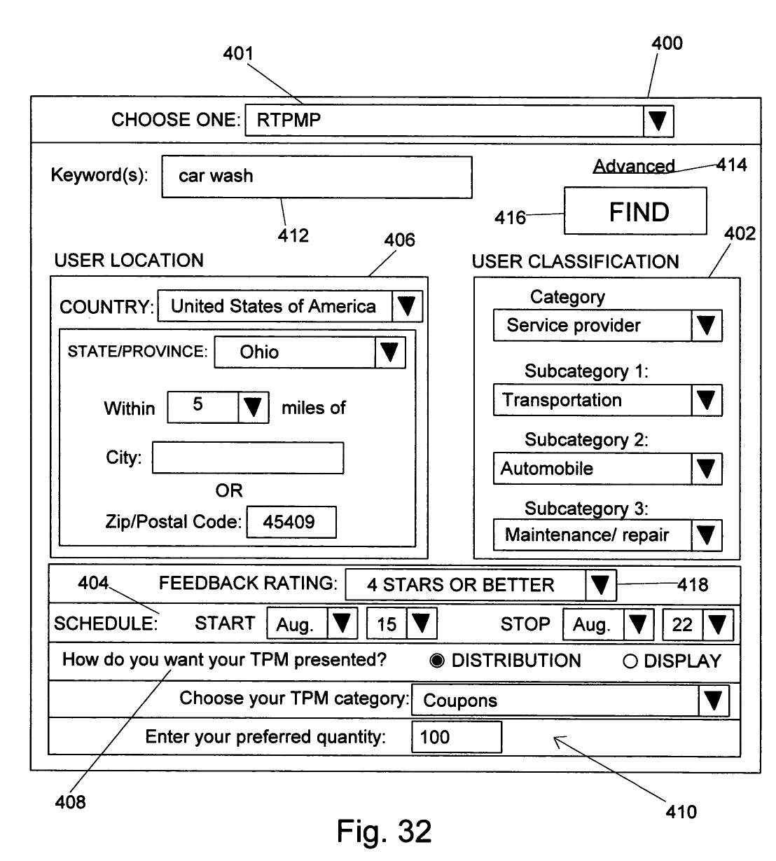

FIG. 32 illustrates a reciprocator choice form 400. The form contains inputs for assigning specific values to query request variables including entity-characteristics-data variables 402, schedule-data variables 404, geographic-location-data variables 406, presentation-data variables 408, TPM-data variables 410, and keyword-data variables 412.

The advanced link 414 displays a reciprocator choice form (not shown) that includes not only the form inputs of form 400, but also additional form inputs for additional types of query request variables. These additional for inputs include the inputs in forms 310-316.

After providing desired form inputs, the form data is sent to the web server by clicking the find button 416, where it is handled as a request for user data (U) as described above. Selected users (users having RTPMP variable values that conform to form inputs) and parts of their associated user data (U) are returned for display as a web page.

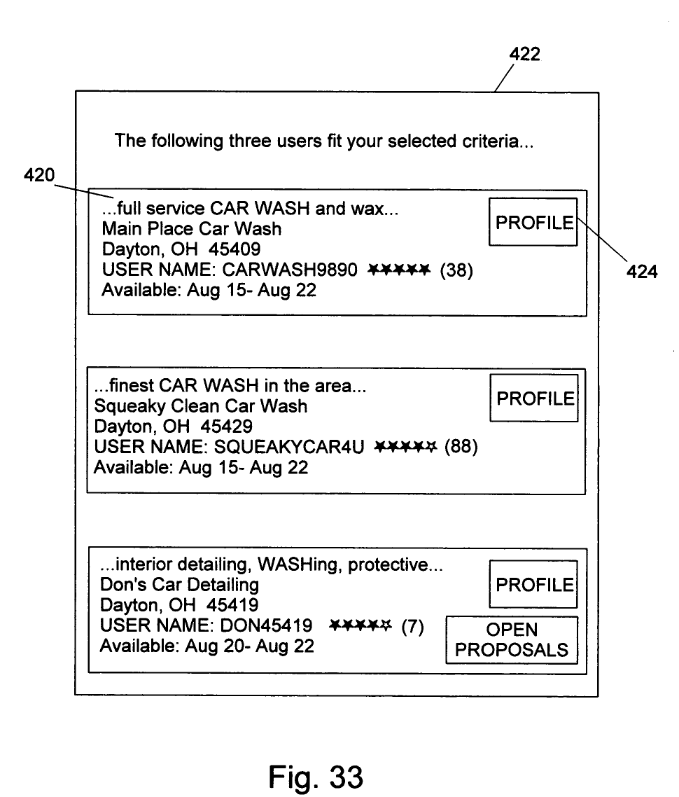

For example, using the form inputs shown in FIG. 32, three users may be found. Referring to FIG. 33, these three users and selected parts 420 of their associated user data (U) are returned from the RTPMP enabling system for display as a web page 422.

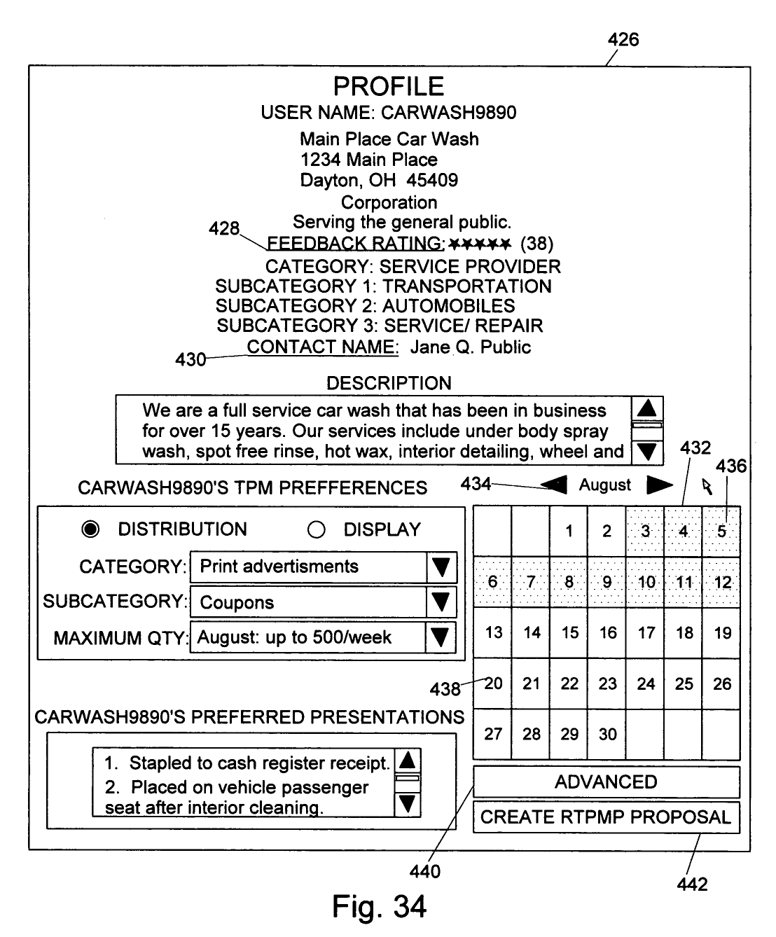

By clicking on the profile button 424, a profile web page 426 of additional user data (U) can be reviewed as shown in FIG. 34. This profile includes a link 428 for viewing feedback the user has received from other users, a link 430 for sending a message to the contact person, and a monthly schedule 432. Buttons 434 are pressed to change the month. Dates with shading 436 indicate that the user is not available for RTPMP, while un-shaded dates 438 indicate the user is available for RTPMP. The advanced button 440 displays additional, more detailed information available concerning the user, such as inputs from forms 334, 346, and 342.

When a reciprocator is chosen, the create proposal button 442 is pressed to begin the next stage: the RTPMP proposal stage.

RTPMP Proposal Stage

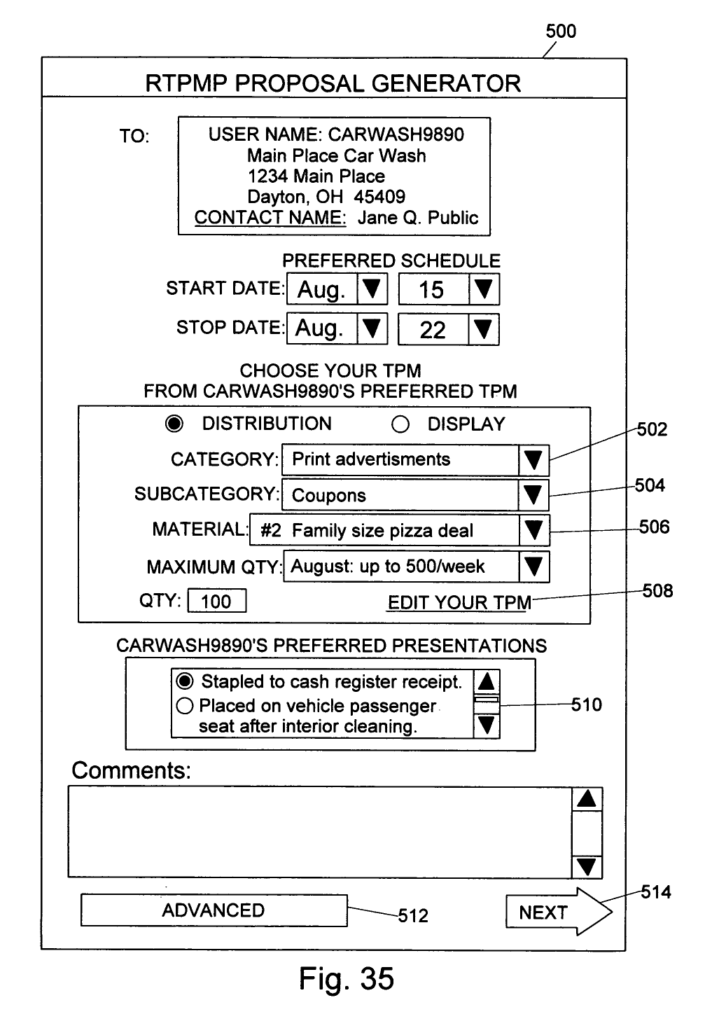

The third stage is the RTPMP proposal stage. In this stage, RTPMP proposals are generated and sent to the chosen reciprocators. FIG. 35 illustrates a form 500 used to generate an RTPMP proposal. The form 500 includes inputs for preferred schedule of RTPMP, desired TPM to be presented, desired presentations, and comments.

The inputs for selection of preferred schedule of RTPMP include only those dates that the chosen reciprocator is available for RTPMP. The category 502 and subcategory inputs 504 for selection of TPM include only those categories and subcategories of TPM that the chosen reciprocator is willing to present. The material selection 506 allows the user generating the proposal to choose from any of their own TPM that belongs to the TPM category and subcategory selected. This insures that the chosen reciprocator is willing to present the particular TPM chosen by the user generating the proposal. The edit your TPM link 508 allows a user to add (form 334), delete, or modify their TPM materials. The presentations selections 510 list all the presentations that the chosen reciprocator is willing to use for the selected TPM material.

The advanced button 512 in form 500 allows the user generating the proposal to see any additional detailed TPM data and presentation data, such as the detailed data input in forms 334, 346, and 342.

When the form is completed, the next button 514 is clicked. Next, the information in the completed proposal form is displayed for final inspection. If the proposal is incorrect, the user returns to form 500 to make corrections. If the proposal is correct, information in the completed proposal is sent to the chosen reciprocator. The proposal is saved as user data (U) for the chosen reciprocator and the user that generated the proposal. A proposal alert is shown to the chosen reciprocator after login and a proposal alert email is also sent to the chosen reciprocator.

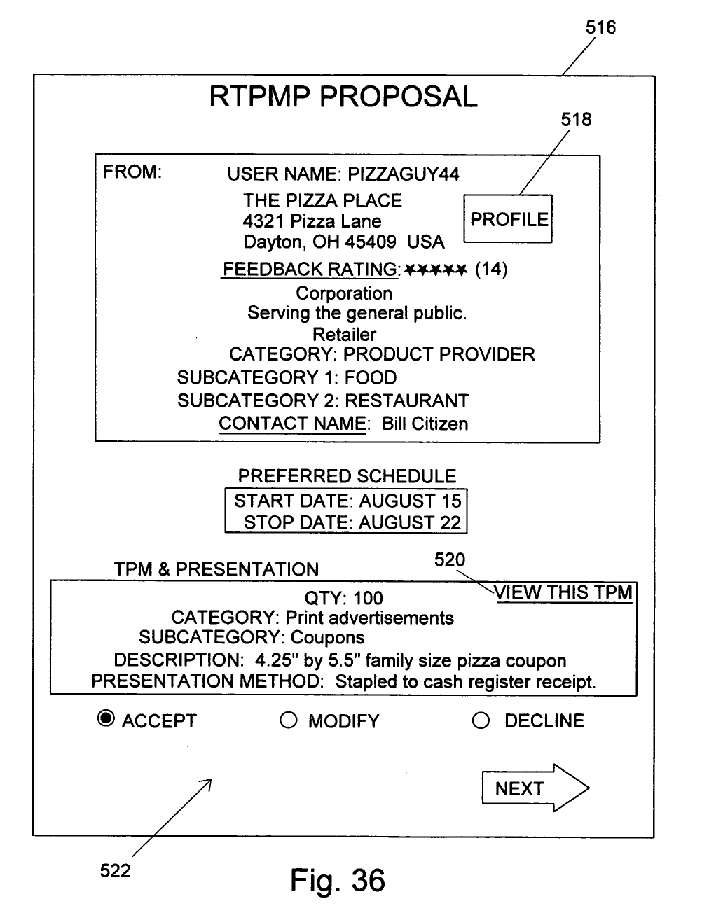

As shown in FIG. 36, a web page 516 with information from the completed proposal generator form and additional information about the user that generated the proposal are sent to the chosen reciprocator. By clicking the profile button 518, the chosen reciprocator can see the profile of the user that generated the proposal. If the user generating the proposal has an illustration (picture, etc.) of the proposed TPM online, the view this TPM link 520 provides a pop-up window containing the illustration for inspection.

The chosen reciprocator may accept the proposal, deny the proposal, or modify the proposal according to which radio button 522 is chosen.

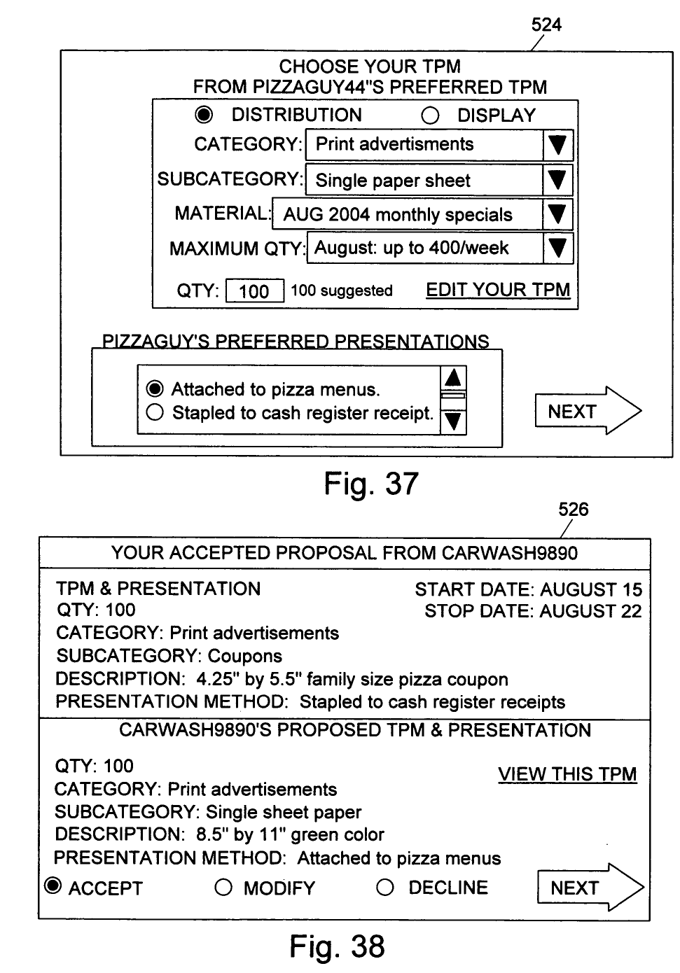

If the RTPMP proposal is accepted, the chosen reciprocator selects the accept radio button and clicks on the next button. Next, the chosen reciprocator generates a return proposal including the chosen reciprocator's desired TPM and the chosen reciprocator's desired presentation. FIG. 37 illustrates a form 524 used to generate the return proposal.

Similar to form 500, the category and subcategory inputs for selection of TPM in form 524 include only those categories and subcategories of TPM that the user that generated the original proposal is willing to present. The material selection allows the user generating the return proposal to choose from any of their own TPM that belongs to the TPM category and subcategory selected. This insures that the user that generated the original proposal is willing to present the particular TPM chosen by the user generating the return proposal. The edit your TPM link allow user to add, delete, or modify their TPM materials. The presentations selections list all the presentations that the user that generated the original proposal is willing to use for the selected TPM material.

After form 524 is completed, the next button is clicked. Next, the information in the completed return proposal form is displayed for final inspection. If the return proposal is incorrect, the user returns to form 524 to make corrections. If the proposal is correct, information in the completed return proposal is sent to the user that made the original proposal. The return proposal is saved as user data (U) for the chosen reciprocator and the user that generated the original proposal. A return proposal alert is shown to the user that made the original proposal after login and a return proposal alert email is also sent.

Referring to FIG. 38, the user making the original proposal receives form 526. This form contains an indication of these proposed choices, notification of acceptance of the original proposal, and the selection inputs 522 identical to those in form 516 are then returned to the user making the original proposal. The user making the original proposal can may accept the return proposal, deny the return proposal, or modify the return proposal. If the return proposal is accepted, users move on to the next stage: the RTPMP performance stage.

If the modify selection is chosen for either the original or the return proposal, the proposal generator form (form 500 or 524 respectively; completed with the proposed inputs) is shown, so that any of the inputs can be modified and returned. The returned, modified proposal and the radio button inputs 522 in form 516 are then returned to the user making the original proposal. Again, the proposal may be denied, further modified, or accepted. Modifications can continue until acceptance is reached or until denial.

If the deny selection is chosen for either the original or the second proposal, the next button leads to a denial response form (not shown). The denial response form includes a comment text area where an explanation of the denial can be input and returned to the user making the proposal.

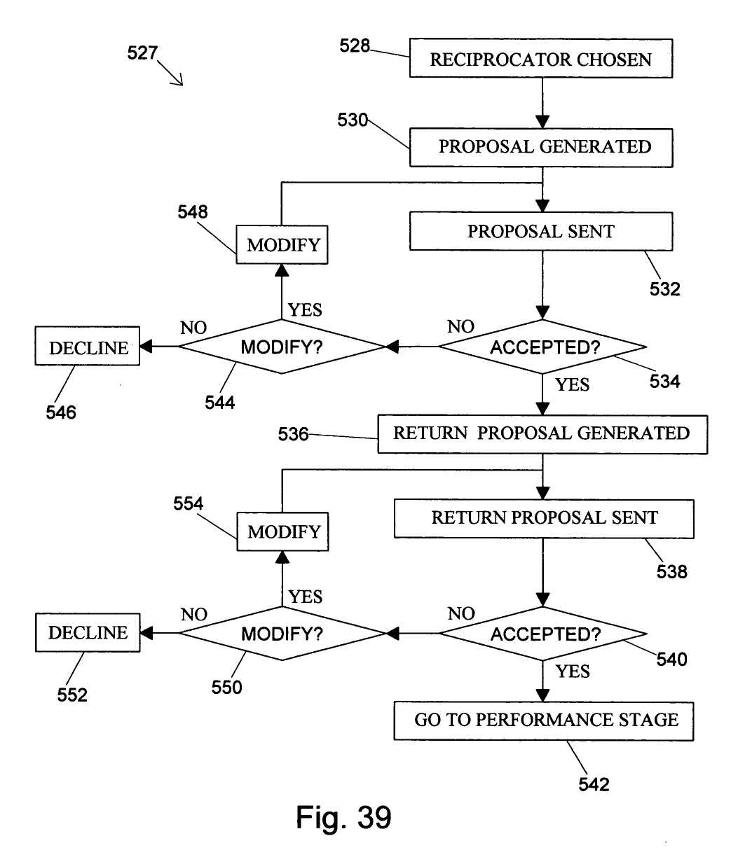

FIG. 39 illustrates the proposal stage process 527 described above. After choosing a reciprocator 528, a proposal is generated 530 and sent 532 to the chosen reciprocator. The chosen reciprocator then makes a decision 534. A return proposal is generated 536 and sent 538 by the chosen reciprocator, if this original proposal is accepted.

Next, the user that made the original proposal makes a decision 540. If the user that made the original proposal accepts the return proposal, the users move to the RTPMP performance stage 542.

If either the original proposal or the return proposal is not accepted, decisions 544, 550 are made whether or not to modify the proposals. If no modifications are desired, the user will decline 546, 552 the proposal. If modifications are desired, the modifications will be made 548, 554 and the proposal retuned to the sending user. This back and forth process continues until the proposal is accepted or declined.

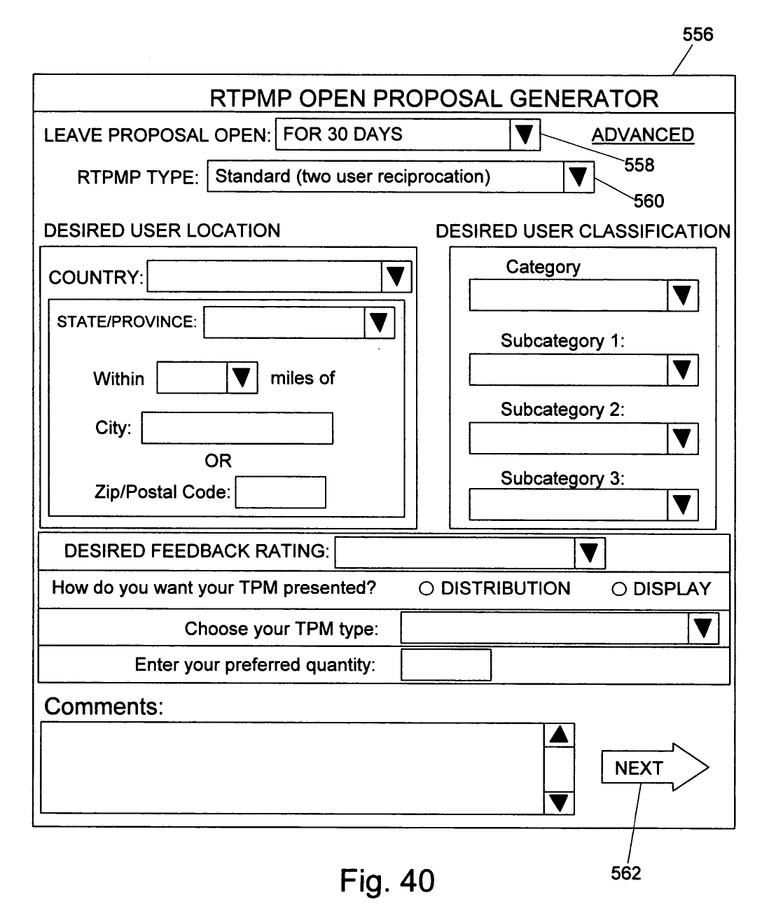

Additionally, RTPMP proposals are generated without first choosing a reciprocator. These RTPMP proposals are referred to as open RTPMP proposals. A form 556 for generating an open RTPMP proposal is shown in FIG. 40. The form has inputs for desired user location, desired user classification, desired feedback rating, desired presentation, desired presentations, and desired quantity, and comments The form also has a pull down list 558 for selecting the time duration of the proposal, and a pull down list 560 for selecting the type of RTPMP. Selections in pull down list 560 include standard (two user reciprocation), and three or more user reciprocation.

After completing form 556, the user clicks on the next button 562. Next, the information in the completed open RTPMP proposal form is displayed for final inspection. If the open RTPMP proposal is incorrect, the user returns to form 556 to make corrections. If the proposal is correct, information in the completed open RTPMP proposal is stored as user data (U) for the user that generates the open proposal.

During the reciprocator choice stage, users find open RTPMP proposals by selecting the “find open RTPMP proposals” selection in pull down list 401 located in form 400. With that selection, a completed form 400 is used to find open RTPMP proposals having information that conforms to the inputs in form 400.

Open proposals are an effective way to enable RTPMP with three or more users, for example the RTPMP shown in FIGS. 3 and 4.

RTPMP Performance Stage

The next stage is the RTPMP performance stage. In this stage, users strive to perform RTPMP according to the agreed RTPMP proposal. To aid users striving to perform according to the agreed proposal, the web site provides a system of RTPMP performance confirmations.

During the RTPMP performance stage, each user arranges delivery of their TPM to its presenter, and receives the delivery of the TPM of another user. Presentations of the TPM subsequently occur according to the agreed RTPMP proposal.

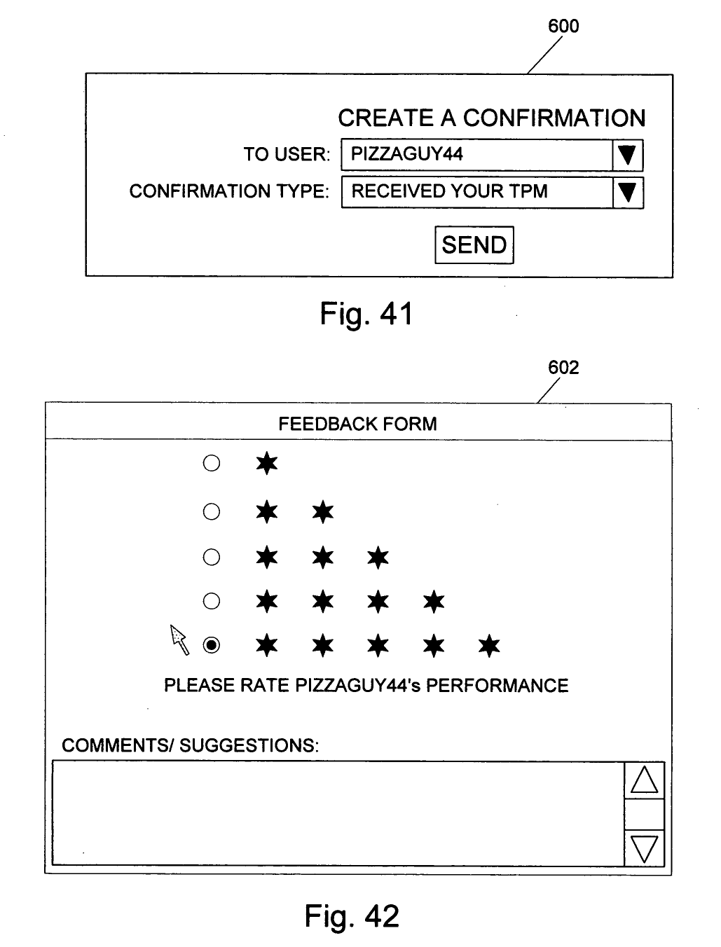

To insure performance according to the agreed RTPMP proposal, the web site allows users to electronically confirm outgoing TPM delivery actions, the receipt of TPM, the start of presentations, and the end of presentations. FIG. 41 illustrates a confirmation generator form 600 wherein the user receiving the confirmation and the type of confirmation are selected from pull down lists. After these selections are made, the send button is clicked to send the confirmation. Users are alerted to incoming confirmations after they login to the web site and also by email.

These confirmations ensure RTPMP proceed according to the agreed RTPMP proposal. For example, if an outgoing TPM delivery action confirmation is sent to a user but the user never receives the TPM, no confirmation will be sent to confirm the expected receipt of the TPM. The lack of a receipt confirmation serves as an alert to a possible problem that could hinder the smooth performance of the agreed RTPMP proposal. With this alert, an inquiry and any ensuing corrective action can be initiated to ensure RTPMP proceed according to the agreed RTPMP proposal.

Feedback Stage

The next stage is the feedback stage. In the feedback stage, users provide an overall rating of each other's actions during the now completed performance stage, and users provide specific comments and/or suggestions.

To provide feedback, users input ratings into a rating system, and input comments and/or suggestions. FIG. 42 illustrates a form 602 having a star input rating system. Users select a rating from least desirable performance (one star) to most desirable performance (five stars). Also, form 602 provides a text input for typing comments and suggestions.

When providing feedback, expectations of the accepted proposal are considered. These considerations may include proper and timely delivery of TPM, proper and timely confirmations, proper and timely presentations, and courteous communication.

As shown above in forms 422 and 426, the web site displays an accumulated rating along with the total number of ratings for each user, which gives other users an overall indication of past performance. By clicking the feedback-rating link 428, the web site also provides links to the individual ratings, comments, and suggestions for further evaluation when desired.

Users benefit from receiving ratings, comments, and suggestions concerning their performance. Ratings provide an incentive for timely and proper performance. Comments provide specific indications of current shortcomings. Suggestions provide methods for improving future performance.

The rating system and the forum for comments both benefit users in general. Each user accumulates a group of ratings and comments associated with their performance. During the RTPMP choice stage, these rating and comments provide an important variable to facilitate informed choices for every user.

RTPMP Management Stage

The next stage is the RTPMP management stage. In this stage, users manage data from completed RTPMP. Data from completed RTPMP is stored as specific values of RTPMP variables for each user. These variables include variables used in the RTPMP proposal stage, the RTPMP performance stage, and the feedback stage. They also include variables created by the users in the management stage. Because data from completed RTPMP is specific to a user, it is stored and processed as user data (U) as described above.

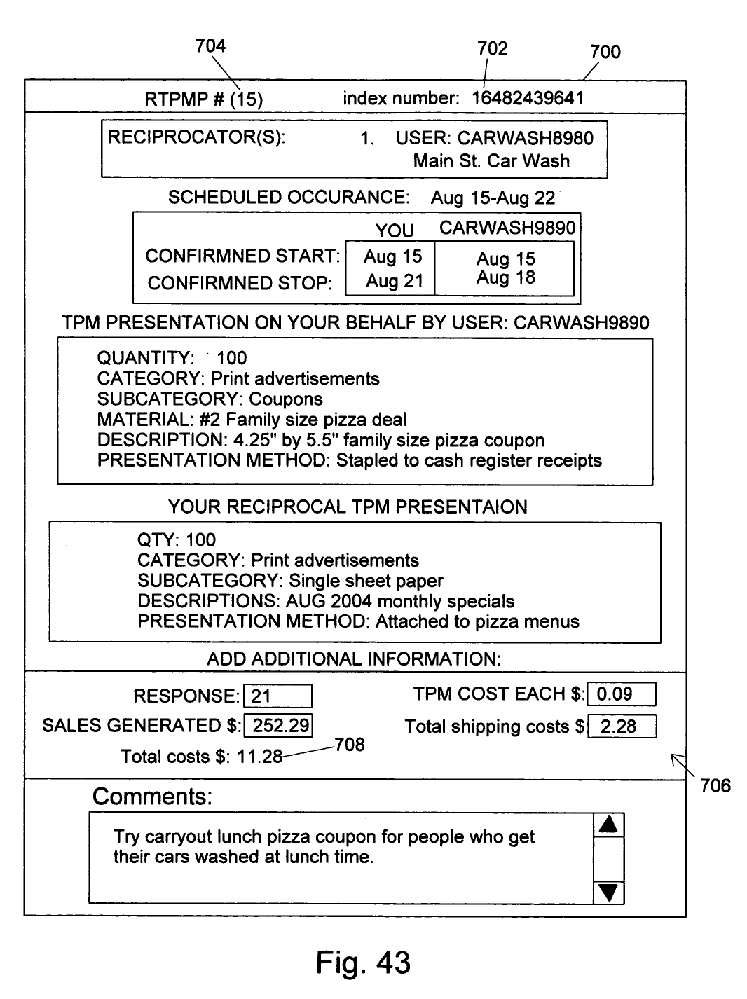

FIG. 43 illustrates a form 700 used to display data from completed RTPMP. As illustrated in form 700, data from completed RTPMP includes data from the agreed RTPMP proposal. This data includes the scheduled occurrence of RTPMP, the reciprocators, and the TPM and presentations used.

Data from the completed RTPMP also includes the confirmed start and stop dates from the performance stage, an index number 702 to identify the RTPMP records among all users, and a sequential number 704 to identify and sequence the RTPMP for the particular user.

Form 700 also includes inputs for additional pertinent data concerning completed RTPMP. These inputs include a comment text area, and inputs 706 for assigning values to variables created by the user. As these values are input, other variables 708 created by the user are displayed which are dependent on the input values. For example, as the number 21 is input in the box labeled response, response rate is displayed as 21%. Response rate has been defined by the user as value input for response, divided by quantity of TPM, multiplied by 100.

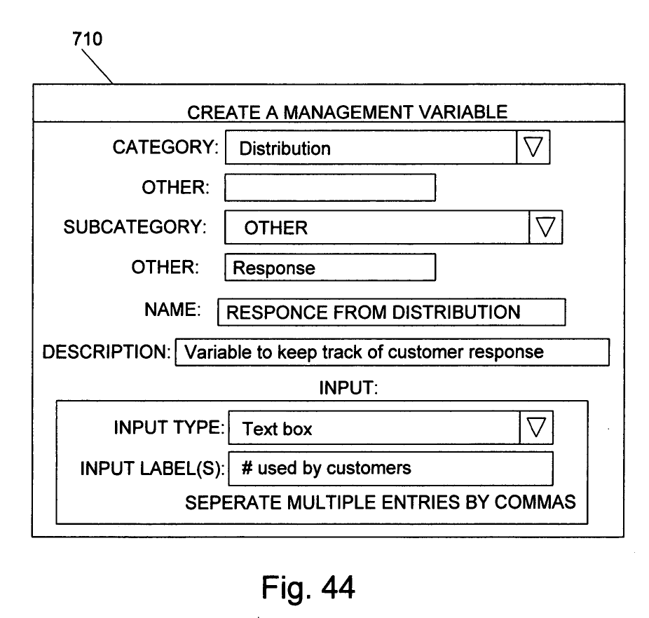

Users create the variables in form 700 by using form 710 illustrated in FIG. 44. Form 710 includes pull down lists for category and subcategory to properly categorize the new variable. If no suitable category or subcategory exists, the user can select “other” and type a suitable category or subcategory into the text boxes labeled other. Form 710 also includes text boxes for naming the variable and describing the variable.

Form 710 also includes a pull down list for selection of the type of input that is used for assigning a value to the variable being created. Depending on the selection made in the input-type pull down list, one or more labels for the inputs of the newly created variable are typed into the input label text box. For example, if “text box” is selected in the input-type pull down list, a label for the text box input of the newly created variable is typed into the input label text box. In the input label text box, multiple labels are separated by commas for inputs requiring multiple labels (such as radio buttons).

Users can then perform management analysis on RTPMP variables to gain knowledge. This knowledge can be used to determine proven values for RTPMP variables to improve future RTPMP, select exploratory values for RTPMP variables for future RTPMP, and improve the management process by determining new variables to be created and possibly eliminating some created variables.

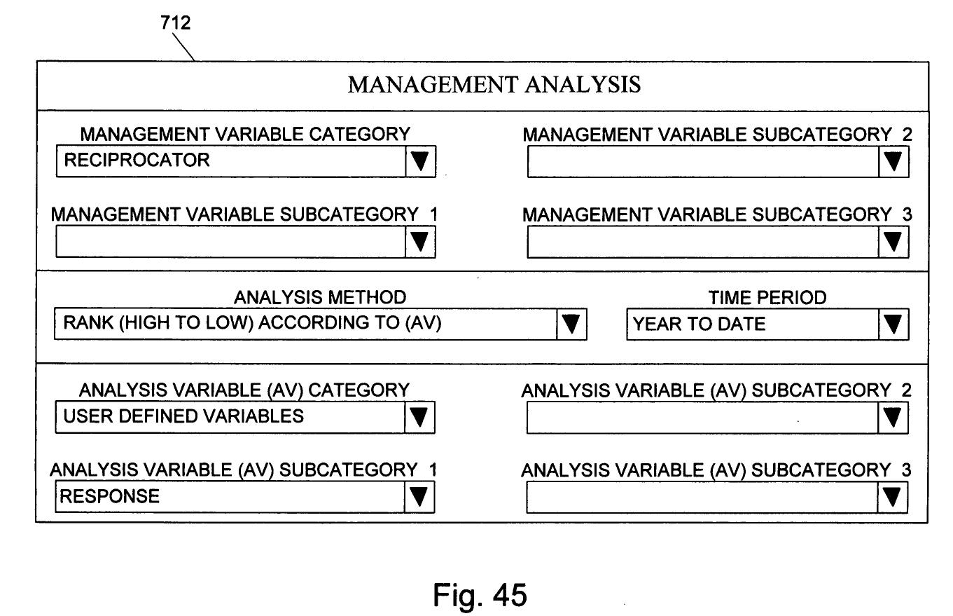

FIG. 45 shows a form 712 for performing management analysis of RTPMP variables. The RTPMP variables selected for analysis are referred to as management variables and the RTPMP variables used to analyze the management variable are referred to as analysis variables. The form includes pull down lists for selection of the management variable, and selection of the analysis variable. The form also includes pull down list for selection of the analysis method and the time period.

For example, a user might select the values shown in form 712. In this case, when the go button is pressed, a web page listing reciprocators used in the current year will be returned. The list of reciprocators will be ranked according to the response rate which is a variable created by the user. The ranking will be from the highest value of response rate to the lowest value.

Analysis methods also include ranking (low to high) according to (AV), sum total, and display. Sum total allows a user to see a sum total of all values of a management variable over a selected time period. Display allows user to display values of management variables during a selected time period.

### EXAMPLE

A brief example of a typical use of the website is now given. The example extends the example described above (under heading “Detailed Description of Preferred Embodiment” and subheading “RTPMP”) concerning RTPMP between a pizza restaurant and a car wash to include use of the website also described above.

In this example, the pizza restaurant and the car wash are both already registered users of the website (having user names pizzaguy44 and carwash9890 respectively), and therefore both have completed the data gathering stage. For example, during registration, the car wash initially completed form 300 where it selected the service provider radio button as shown. Furthermore, the car wash also completed forms 310, and forms 314-318 as shown. Forms 324, 326, 328-340 were also completed.

Referring now to the reciprocator choice stage, the pizza restaurant completes form 400 as shown. After clicking the find button, form 422 is returned. When profile button 424 is clicked, form 426 appears. Having chosen carwash9890 as a suitable reciprocator, the pizzaguy44 clicks button 442 to begin the proposal stage.

To begin the proposal stage, form 500 is completed as shown and then the next button is clicked. Form 516 is then sent to carwash9890. Carwash 9890 selects the accept radio button to accept the proposal and then clicks the next button. Next carwash9890 completes the return proposal form 524 and clicks the next button. Pizzaguy44 receives and accepts the information in form 526, which completes the proposal stage.

Next is the performance stage. Both users arrange delivery of TPM. Confirmations are sent by each user using form 600 to confirm outgoing TPM delivery actions, the receipt of TPM, the start of presentations, and the end of presentations. After receiving delivery of each other's TPM, presentations of the TPM begin on the agreed start date.

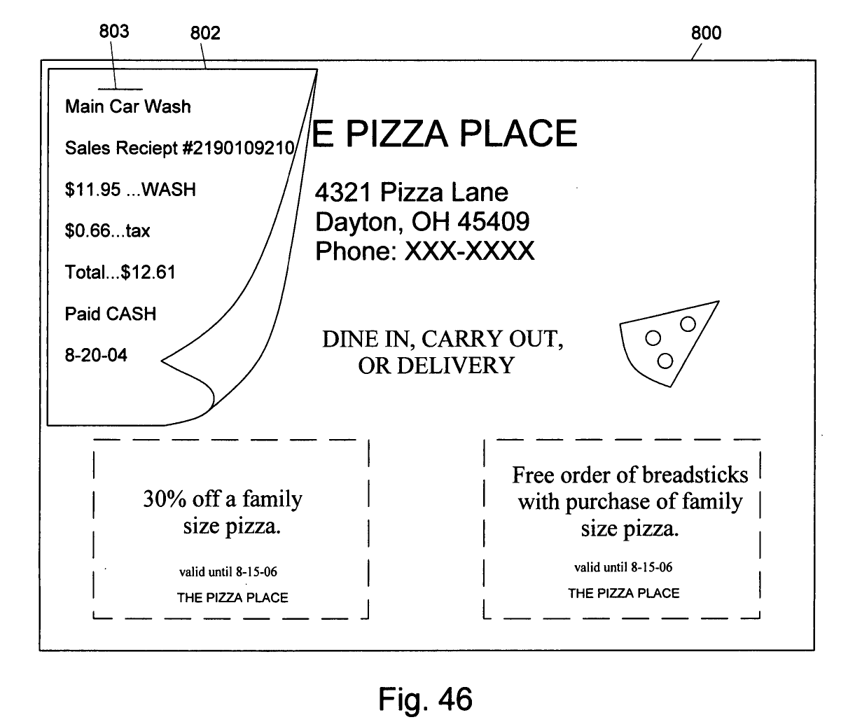

As shown in FIG. 46, carwash9890 staples 803 a coupon 800 of pizzzaguy44 to a car wash receipt 802 to present to a car wash customer as agreed in the proposal.

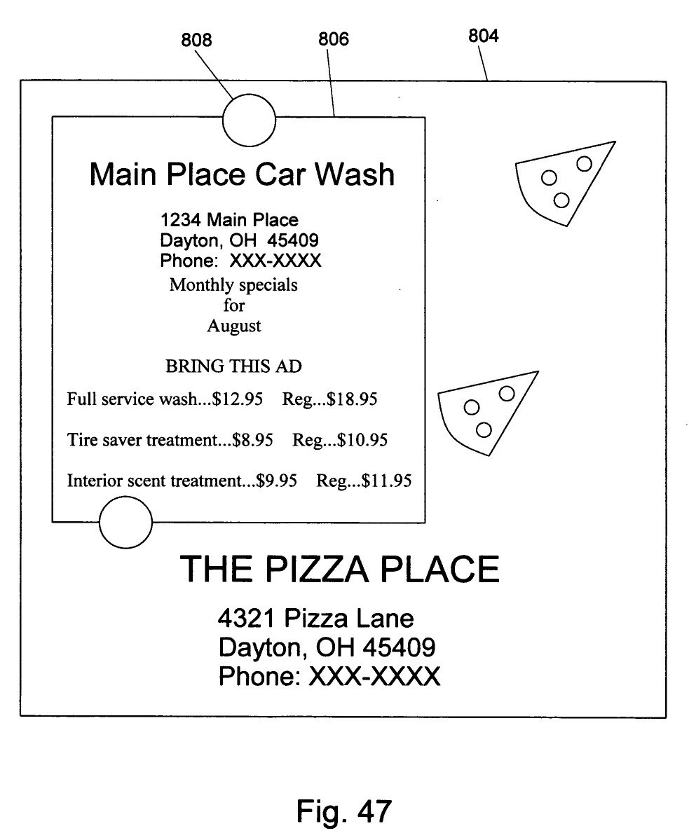

As shown in FIG. 47, pizzaguy44 attaches a single sheet, paper advertisement 806 of carwash9890 to a pizza menu 804 using small stickers 808 to present to a pizza customer as agreed in the proposal.

After each user has repeated this process 100 times to use up all the agreed quantities of TPM, stop date confirmation are sent using form 600. Next users move on to the feedback stage.

In the feedback stage, users rate each other's performance according to the agreed proposal using form 602.

Each user receives an effective and economical promotion for their traditional so called brick-and-mortar small business by utilization of the RTPMP system. Both users can utilize RTPMP management services to input data concerning response 706 as shown in form 700. RTPMP management analysis services can also be utilized (form 712) to gain RTPMP knowledge for improving future RTPMP.

### CONCLUSIONS

It will be obvious to one skilled in the art of the present invention that many different kinds and types of hardware, software, scripting languages and the like can be used to implement the services provided by the web pages of the present invention. In an exemplary embodiment consistent with the present invention, the web server and the data base server can be implemented in a variety of ways including server computers from Sun Microsystems Corporation having ultraSPARC® processors with accompanying SOLARIS® operating systems and server computers using open source Linux operating systems; the database can be implemented in a variety of ways including a disk array also from Sun Microsystems Corporation; the database software and associated scripts for the particular database structures and processing needed to store and provide the user data (U) content of the web pages to the web server can be implemented in a variety of ways including Sun One Directory Sever® from Sun Microsystems Corporation, Oracle database software from Oracle Corporation, mySQL, or postgreSQL; the web server software can be implemented in a variety of ways including open source Apache web server or Sun ONE Web Server® from Sun Microsystems; scripts stored in a memory device on the web server for providing the particular user data (U) and general data (G) content of the web pages may be implemented in a variety of ways including use of HTML and XML which can be delivered dynamically on the server-side using server-side scripting languages such as PHP, or JSP; client-side scripting for such tasks as determining browser capabilities can be implemented using javascript; formatting of web pages can be implemented using Cascading Style Sheets; and the web browser software can be implemented in a variety of ways including Internet Explorer® from Microsoft Corporation.

In general, methods and systems consistent with the present invention enable Reciprocal Tangible-Promotional-Materials Presentations (RTPMP) among a plurality of entities. The above detailed description enables one skilled in the art of the present invention to make, use, and thus experience the novel benefits of the present invention. It will be apparent to one skilled in the art that other embodiments, modifications, and variations consistent with the present invention are possible, and that practicing the teachings of the present invention provided herein shall yield still further embodiments, modifications, and variations of the present invention.

For example, a particular preferred platform for providing a website accessible via the Internet is described in detail above, but the present invention may be implemented using a variety of platforms that provide a website accessible via the global Internet.

Furthermore, RTPMP enabling and RTPMP management services were described in detail above using particular web pages having particular form inputs, but a variety of different web pages having a variety of different form inputs may be implemented to provide RTPMP enabling and RTPMP management services.

Thus, although the description above contains many specificities, these should not be construed as limiting the scope of the present invention but as merely providing illustrations of the presently preferred embodiment of the present invention. Therefore, the scope of the present invention should be defined strictly by the appended claims and their equivalents.

1. A method for enabling RTPMP among users of a communications network, comprising the steps of:
gathering RTPMP data for specifically characterizing potential RTPMP from the users via the communications network;
storing the RTPMP data in a data storage device;
allowing the users to manage and maintain currentness of the RTPMP data via the communications network;
receiving requests from the users via the communications network for processed RTPMP-data to enable the RTPMP among the users;
processing the RTPMP data according to the requests to obtain the requested, processed RTPMP-data; and
sending the requested, processed RTPMP-data to the users via the communications network to enable the RTPMP among the users.

2. The method of claim 1 wherein the RTPMP data includes user-characteristics data, geographic-location data, tangible-promotional-materials data, presentation data, and schedule data.

3. The method of claim 2 wherein the processing of the RTPMP data enables a RTPMP reciprocator-choice-stage, a RTPMP proposal-stage, a RTPMP performance-stage, and a RTPMP feedback-stage.

4. The method of claim 3 further comprising the steps of:
storing data associated with completed RTPMP; and
performing management processing on the data associated with completed RTPMP to allow the users to analyze the data associated with completed RTPMP to gain RTPMP knowledge.

5. The method of claim 4 further comprising one or more of the following steps:
providing a graphical user interface to the users that structures the input of the RTPMP data specifically for allowing a first user among the users to block one or more second users among the users from proposing the RTPMP based on preferences of the first user;
providing a graphical user interface to the users that structures the input of the RTPMP data specifically for modeling reciprocal display of tangible-promotional-materials preferences and reciprocal distribution of tangible-promotional-materials preferences;
providing a graphical user interface to the users that structures the input of the RTPMP data specifically for creating and managing a schedule directed to the RTPMP;
providing a graphical user interface to the users that structures the input of the RTPMP data specifically for categorizing and itemizing tangible promotional materials;
providing a graphical user interface to the users that structures the input of the RTPMP data specifically for specifying characteristics of tangible-promotional-materials including size characteristics;
providing a graphical user interface to the users that structures the input of the RTPMP data specifically for specifying minimum and maximum quantities of tangible-promotional-materials the users are willing to present in a period of time;
providing a graphical user interface to the users that allows the users to manage the RTPMP data to facilitate current RTPMP data;
providing a graphical user interface to a first user among the users that specifically structures the selection of tangible-promotional-materials data, presentation data, and schedule data associated with a second user among the users for facilitating the creation of a RTPMP proposal satisfactory to the second user;
providing a graphical user interface to the second user that specifically structures the selection of tangible-promotional-materials data, presentation data, and schedule data associated with the first user for facilitating the creation of a RTPMP proposal satisfactory to the first user;
providing a graphical user interface to the users that structures the input of the RTPMP data specifically for allowing the users to send RTPMP confirmations;
providing a graphical user interface that structures the input of the RTPMP data specifically for allowing the users to create RTPMP management variables to facilitate the users in gaining customized RTPMP-knowledge from the data associated with completed RTPMP;
providing a graphical user interface for input of the RTPMP data specifically for allowing the users to leave feedback after completing the RTPMP.

6. A computer system for enabling RTPMP among users of a computer network, the computer system comprising:
a data storage device for storing a plurality of RTPMP variables that together model potential RTPMP, the RTPMP variables having associated values; and
a processor coupled to the data storage device, the processor being operative to perform the steps of:
providing a first graphical user interface to the users via the computer network, the first graphical user interface characterized by a plurality of data inputs for structuring the input of RTPMP data corresponding to the RTPMP variables;
accepting the RTPMP data through the first graphical user interface from the users via the computer network to establish the values of the RTPMP variables for modeling the users for the potential RTPMP;
storing the RTPMP data in the data storage device;
providing a second graphical user interface to a first user among the users via the computer network, the second graphical user interface characterized by one or more inputs for candidate data for defining a model of a potential RTPMP candidate;
accepting the candidate data through the second graphical user interface from the first user via the computer network;
comparing the candidate data to the RTPMP data of the users to obtain zero or more associated candidate-users among the users;
presenting the RTPMP data associated with the candidate users to the first user via the computer network for evaluation of the potential RTPMP; and if desired by the first user,
facilitating communication between the first user and one of the candidate users via the computer network to enable the RTPMP.

7. The computer system of claim 6 wherein the RTPMP data includes user-characteristics data, geographic-location data, tangible-promotional-materials data, presentation data, and schedule data.

8. The computer system of claim 7 wherein the processor is further operative to store data associated with completed RTPMP, and perform management processing on the data associated with completed RTPMP to allow the users to gain RTPMP knowledge.

9. The computer system of claim 8 wherein the processor is further operative to execute one or more of the following steps:
providing a graphical user interface to the users that structures the input of the RTPMP data specifically for allowing a first user among the users to block one or more second users among the users from proposing the RTPMP based on preferences of the first user;
providing a graphical user interface to the users that structures the input of the RTPMP data specifically for modeling reciprocal display of tangible-promotional-materials preferences and reciprocal distribution of tangible-promotional-materials preferences;
providing a graphical user interface to the users that structures the input of the RTPMP data specifically for creating and managing a schedule directed to the RTPMP;
providing a graphical user interface to the users that structures the input of the RTPMP data specifically for categorizing and itemizing tangible promotional materials;
providing a graphical user interface to the users that structures the input of the RTPMP data specifically for specifying characteristics of tangible-promotional-materials including size characteristics;
providing a graphical user interface to the users that structures the input of the RTPMP data specifically for specifying minimum and maximum quantities of tangible-promotional-materials the users are willing to present in a period of time;
providing a graphical user interface to the users that allows the users to manage the RTPMP data to facilitate current RTPMP data;
providing a graphical user interface to a first user among the users that specifically structures the selection of tangible-promotional-materials data, presentation data, and schedule data associated with a second user among the users for facilitating the creation of a RTPMP proposal satisfactory to the second user;
providing a graphical user interface to the second user that specifically structures the selection of tangible-promotional-materials data, presentation data, and schedule data associated with the first user for facilitating the creation of a RTPMP proposal satisfactory to the first user;
providing a graphical user interface to the users that structures the input of the RTPMP data specifically for allowing the users to send RTPMP confirmations;
providing a graphical user interface that structures the input of the RTPMP data specifically for allowing the users to create RTPMP management variables to facilitate the users in gaining customized RTPMP-knowledge from the data associated with completed RTPMP;
providing a graphical user interface for input of the RTPMP data specifically for allowing the users to leave feedback after completing the RTPMP.

10. A computer-readable medium containing instructions for enabling RTPMP among users of a computer network, wherein the instructions, when executed, comprise the steps of:
storing a plurality of RTPMP variables that together form a model of potential RTPMP among the users, the RTPMP variables having associated values;
providing a first graphical user interface to the users via the computer network, the first graphical user interface characterized by a plurality of data inputs for structuring the input of RTPMP data corresponding to the RTPMP variables;
accepting the RTPMP data through the first graphical user interface from the users via the computer network to define the values of the RTPMP variables, thus establishing actual instances of the RTPMP model;
providing a second graphical user interface to a first user among the users via the computer network, the second graphical user interface characterized by one or more inputs for data defining a prototype instance of the RTPMP model;
accepting the data defining a prototype instance of the RTPMP model through the second graphical user interface from the first user via the computer network;
selecting one or more second users among the users, the one or more second users being associated with the defined prototype-instance of the RTPMP model;
presenting data associated with the actual instances of the RTPMP model of the selected, one or more second users to the first user for evaluation of the potential RTPMP; if desired by the first user,
providing a third graphical user interface for creation and communication of a first RTPMP proposal from the first user to a third user among the one or more second users, wherein the first user is facilitated in selecting the RTPMP data complicit with the actual instance of the RTPMP model of the third user to enable creation of the first RTPMP proposal satisfactory to the third user; and if desired by the third user,
providing a fourth graphical user interface for creation and communication of a second RTPMP proposal from the third user to the first user, wherein the third user is facilitated in selecting the RTPMP data complicit with the actual instance of the RTPMP model associated with the first user to enable creation of the second RTPMP proposal satisfactory to the first user.

11. The computer-readable medium of claim 10 wherein the RTPMP data includes user-characteristics data, geographic-location data, tangible-promotional-materials data, presentation data, and schedule data.

12. The computer-readable medium of claim 11 wherein the instructions, when executed, further comprise the steps of:
storing data associated with completed RTPMP; and
performing management processing on the data associated with completed RTPMP to allow the users to gain RTPMP knowledge.

13. The computer-readable medium of claim 12 wherein the instructions, when executed, further comprise one or more of the following steps:
providing a graphical user interface to the users that structures the input of the RTPMP data specifically for allowing a first user among the users to block one or more second users among the users from proposing the RTPMP based on preferences of the first user;
providing a graphical user interface to the users that structures the input of the RTPMP data specifically for modeling reciprocal display of tangible-promotional-materials preferences and reciprocal distribution of tangible-promotional-materials preferences;
providing a graphical user interface to the users that structures the input of the RTPMP data specifically for creating and managing a schedule directed to the RTPMP;
providing a graphical user interface to the users that structures the input of the RTPMP data specifically for categorizing and itemizing tangible promotional materials;
providing a graphical user interface to the users that structures the input of the RTPMP data specifically for specifying characteristics of tangible-promotional-materials including size characteristics;
providing a graphical user interface to the users that structures the input of the RTPMP data specifically for specifying minimum and maximum quantities of tangible-promotional-materials the users are willing to present in a period of time;
providing a graphical user interface to the users that allows the users to manage the RTPMP data to facilitate current RTPMP data;
providing a graphical user interface to the users that structures the input of the RTPMP data specifically for allowing the users to send RTPMP confirmations;
providing a graphical user interface that structures the input of the RTPMP data specifically for allowing the users to create RTPMP management variables to facilitate the users in gaining customized RTPMP-knowledge from the data associated with completed RTPMP;
providing a graphical user interface for input of the RTPMP data specifically for allowing the users to leave feedback after completing the RTPMP.

14. A method for enabling RTPMP among users of computer network, the method comprising:
providing a first graphical user interface to the users via the computer network, the first graphical user interface characterized by a plurality of data inputs for structuring the input from the users via the computer network of RTPMP data characterizing the RTPMP;
accepting the RTPMP data through the first graphical user interface from the users via the computer network;
storing the RTPMP data in a data storage device;
providing a second graphical user interface to a first user among the users via the computer network, the second graphical user interface characterized by one or more inputs for candidate data for defining a potential RTPMP candidate;
accepting the candidate data through the second graphical user interface from the first user via the computer network;
comparing the candidate data to the RTPMP data of the users to obtain zero or more associated candidate-users among the users;
presenting the RTPMP data associated with the candidate users to the first user via the computer network for evaluation of potential RTPMP; if desired by the first user,
providing a third graphical user interface for creation and communication of a first RTPMP proposal from the first user to a first candidate-user among the candidate users, wherein the first user is facilitated in selecting the RTPMP data associated with the first candidate-user to enable creation of the first RTPMP proposal satisfactory to the first candidate-user; and if desired by the first candidate-user,
providing a fourth graphical user interface for creation and communication of a second RTPMP proposal from the first candidate-user to the first user, wherein the first candidate-user is facilitated in selecting the RTPMP data associated with the first user to enable creation of the second RTPMP proposal satisfactory to the first user.

15. The method of claim 14 wherein the RTPMP data includes user-characteristics data, geographic-location data, tangible-promotional-materials data, presentation data, and schedule data.

16. The method of claim 15 further comprising the step of processing the RTPMP data to provide the users a RTPMP performance-stage, and a RTPMP feedback-stage.

17. The method of claim 16 further comprising the steps of:
storing data associated with completed RTPMP; and
performing management processing on the data associated with completed RTPMP to allow the users to analyze the data associated with completed RTPMP to gain RTPMP knowledge.

18. The method of claim 17 further comprising one or more of the following steps:
providing a graphical user interface to the users that structures the input of the RTPMP data specifically for allowing a first user among the users to block one or more second users among the users from proposing the RTPMP based on preferences of the first user;
providing a graphical user interface to the users that structures the input of the RTPMP data specifically for modeling reciprocal display of tangible-promotional-materials preferences and reciprocal distribution of tangible-promotional-materials preferences;
providing a graphical user interface to the users that structures the input of the RTPMP data specifically for creating and managing a schedule directed to the RTPMP;
providing a graphical user interface to the users that structures the input of the RTPMP data specifically for categorizing and itemizing tangible promotional materials;
providing a graphical user interface to the users that structures the input of the RTPMP data specifically for specifying characteristics of tangible-promotional-materials including size characteristics;
providing a graphical user interface to the users that structures the input of the RTPMP data specifically for specifying minimum and maximum quantities of tangible-promotional-materials the users are willing to present in a period of time;
providing a graphical user interface to the users that allows the users to manage the RTPMP data to facilitate current RTPMP data;
providing a graphical user interface to a first user among the users that specifically structures the selection of tangible-promotional-materials data, presentation data, and schedule data associated with a second user among the users for facilitating the creation of a RTPMP proposal satisfactory to the second user;
providing a graphical user interface to the second user that specifically structures the selection of tangible-promotional-materials data, presentation data, and schedule data associated with the first user for facilitating the creation of a RTPMP proposal satisfactory to the first user;
providing a graphical user interface to the users that structures the input of the RTPMP data specifically for allowing the users to send RTPMP confirmations;
providing a graphical user interface that structures the input of the RTPMP data specifically for allowing the users to create RTPMP management variables to facilitate the users in gaining customized RTPMP-knowledge from the data associated with completed RTPMP;
providing a graphical user interface for input of the RTPMP data specifically for allowing the users to leave feedback after completing the RTPMP.
